(19) United States
(12) Patent Application Publication
(10) Pub. No.: US 2012/0147163 A1
(43) Pub. Date: Jun. 14, 2012

(54) METHODS AND SYSTEMS FOR CREATING AUGMENTED REALITY FOR COLOR BLINDNESS

(75) Inventor: Dan Kaminsky, Seattle, WA (US)

(73) Assignee: DAN KAMINSKY HOLDINGS LLC, a corporation of the State of Delaware, Dover, DE (US)

(21) Appl. No.: 13/291,848

(22) Filed: Nov. 8, 2011

Related U.S. Application Data
(60) Provisional application No. 61/411,413, filed on Nov. 8, 2010.

(51) Int. Cl. H04N 7/18; G09G 5/02

(52) U.S. Cl. 348/62; 345/590; 348/E07.085

(57) ABSTRACT

In an embodiment, an image is provided to an augmented reality application program. The program detects colors and modifies the image. In particular, the program may analyze an image of a scene provided by a camera of a portable electronic device that may be problematic for color challenged users. It then modifies one or more colors such that a color challenged user viewing the altered image may perceive the scene colors as the colors would be perceived by a non-color challenged user viewing the scene.

### CROSS-REFERENCE TO RELATED APPLICATIONS

This patent application claims priority to U.S. provisional patent application 61/411,413, filed Nov. 8, 2010, and also claims the benefit of U.S. provisional patent application 61/431,686, filed Jan. 11, 2011, which are all incorporated by reference along with all other references cited in this application.

### BACKGROUND

The present invention relates to the field of information technology, including, more particularly, to systems and techniques for helping color blind people to perceive colors.

Color-blind persons have difficulty distinguishing various colors. Persons whose color vision is impaired include, for example, those who confuse reds and greens (e.g., either protanopia: having defective red cones or deuteranopia: having defective green cones). For these people visual discrimination of color-coded data is practically impossible when green, red or yellow data is adjacent. In the color space of such persons, the red-green hue dimension is missing, and red and green are both seen as yellow; they have only the yellow-blue dimension.

Even people with normal color vision can, at times, have difficulty distinguishing between colors. As for elderly persons, as a person ages clouding of the lenses of their eyes tends to occur, due, for example, to cataracts. The elderly often experience changes in their ability to sense colors, and many see objects as if they have been viewed through yellowish filters. Additionally, over time ultraviolet rays degenerate proteins in the eye, and light having short wavelengths is absorbed and blue cone sensitivity is thereby reduced. As a result, the appearance of all colors changes, yellow tending to predominate, or a blue or a bluish violet color tends to become darker. Specifically, “white and yellow,” “blue and black” and “green and blue” are difficult to distinguish. Similarly, even a healthy individual with “normal” vision can perceive colors differently when they are at an altitude that is greater than they are normally used to, or under certain medications.

To overcome the inability to distinguish colors, such individuals become adept at identifying and learning reliable cues that indicate the color of an object, such as by knowing that a stop sign is red or that a banana is typically yellow. However, absent these cues, the effect of being color-blind is that they are often unable to reliably distinguish colors of various objects and images, including in cases where the color provides information that is important or even critical to an accurate interpretation of the object or image. Common examples of such objects and images include lighted and non-lighted traffic signals, and pie-charts/graphs of financial information and maps. Moreover, with the proliferation of color computer displays, more and more information is being delivered electronically and visually and usually with color coded information via computer graphic systems.

Computer graphics systems are commonly used in most of today's graphics presentation systems for displaying graphical representations of objects on a two-dimensional video display screen. Current computer graphics systems provide highly detailed representations and are used in a variety of applications. Such systems typically come pre-installed with a plethora of accessibility tools for people with disabilities. Yet, providing color corrected graphics for people who suffer from color blindness still remains a challenge.

More than 20 million Americans experience some form of color blindness, which is the inability to distinguish certain colors. When light enters the eye, it passes through several structures before striking the light sensitive receptors in the retina at the back of the eye. These receptors are known as the rods and cones. Essentially, rods are responsible for night vision, and cones are responsible for color vision, functioning best under daylight conditions.

Each of the three types of cones, red cones, blue cones and green cones, has a different range of light sensitivity. It is commonly agreed upon that an individual having normal color vision has a cone population consisting of approximately 74 percent red cones, 10 percent green cones, and 16 percent blue cones. The stimulation of cones in various combinations accounts for the perception of colors. For example, the perception of yellow results from a combination of inputs from green and red cones, and relatively little input from blue cones. If all three cones are stimulated, white is perceived as the color. Defects in color vision occur when one of the three-cone cell coding structures fails to function properly. One of the visual pigments may be functioning abnormally, or it may be absent altogether. Most color-deficient individuals have varieties of red or green deficiency.

There is a need for improved systems and techniques to allow people with color blindness to have visual experiences similar to that of people without color blindness.

### BRIEF SUMMARY OF THE INVENTION

In a specific embodiment, an augmented reality application program is provided for the color blind. The program assists its users in determining colors, differences in colors, or both that would otherwise be invisible to them. In this specific embodiment, the program is based on a theory of the human visual system that somewhere in the human visual system, processing is done on the pure color—the hue—of something seen. The assumption is that there are relatively few hues the visual system actually sees, but for the color blind, hue determination (specifically between red and green) is impeded by slight changes in the eye. The application, through its various modes or filters, can make hues easier to detect, differentiate, or both. The program provides a large number of user-configurable settings and adjustments so that each individual user can find a particular setting that provides desirable results.

In an embodiment, the program is especially helpful to those with anomalous trichromancy, which is not actually blind to any particular color, but represents a lessened ability to differentiate certain reds from certain greens.

Embodiments of the present invention provide a method and apparatus for dynamically modifying computer graphics content for colors, patterns, or both that are problematic for visually challenged, in particular color-blind viewers, prior to display. In particular, graphics content may be modified in various stages of the graphics pipeline, including but not limited to, the render or raster stage, such that images provided to the user are visible to color-blind viewers upon display without further modification. As illustrated and discussed in detail below, embodiments of the present invention may be implemented in hardware, software or a combination thereof.

In a specific embodiment, graphics content in the form of an original screen image (e.g., in pixels or other format) is provided to a color-blind filter of the present invention. The color-blind filter detects colors and modifies images. In particular, the color-blind filter analyzes computer graphics content that may be problematic for color challenged users. It then modifies problematic graphics content such that the graphics content is visible to color challenged users. Display technology such as a graphics card or operating system video card driver displays the modified image.

In a specific implementation, a method includes receiving an image of an object from a camera of a portable electronic device, analyzing, at the portable electronic device, the image to obtain a hue value representing a color of the object, identifying a predetermined range of hue values, where the hue value is within the predetermined range, and the predetermined range is mapped to a specific predetermined hue value, replacing the hue value representing the color of the object with the specific predetermined hue value to color the object using the specific predetermined hue value, and displaying on a screen of the portable electronic device an altered image, where the altered image comprises the object colored using the specific predetermined hue value to permit a color blind person viewing the screen to perceive the color of the object as would be perceived by a non-color blind person viewing the object. The image can be a picture of the object or a streamed live video feed including the object.

Other objects, features, and advantages of the present invention will become apparent upon consideration of the following detailed description and the accompanying drawings, in which like reference designations represent like features throughout the figures.

### BRIEF DESCRIPTION OF THE FIGURES

The patent or application file contains at least one drawing executed in color. Copies of this patent or patent application with color drawing(s) will be provided by the Office upon request and payment of the necessary fee.

FIG. 1 shows a block diagram of a client-server system and network in which an embodiment of the invention may be implemented.

FIG. 2 shows a more detailed diagram of an exemplary client or computer which may be used in an implementation of the invention.

FIG. 3 shows a system block diagram of a client computer system.

FIG. 4A shows a block diagram of a specific embodiment of an augmented reality system.

FIG. 4B shows a screenshot of an image of a shirt after modification by the system.

FIG. 5 shows a screenshot of an unfiltered Ishihara image.

FIG. 6 shows a screenshot of the Ishihara image having been altered by a hue quantize filter of the system.

FIG. 7 shows a screenshot of another unfiltered Ishihara image.

FIG. 8 shows a screenshot of the other Ishihara image having been altered by a hue window filter of the system.

FIG. 9 shows an overall flow for operation of the system.

FIG. 10 shows a screenshot of an unfiltered color wheel.

FIG. 11 shows a screenshot of the color wheel having been altered by the hue quantize filter of the system.

FIG. 12 shows a screenshot of the filter list or mode options.

FIG. 13 shows a screenshot of the color wheel with the hue quantize filter applied and the slider bar adjusted to the far right.

FIG. 14 shows a flow for the hue quantize filter.

FIG. 15 shows a screenshot of the color wheel with the hue quantize filter applied and the slider bar adjusted to the far left.

FIG. 16 shows a screenshot of the color wheel with the hue quantize filter applied and the slider bar adjusted to a position between a middle position and the far right.

FIG. 17 shows a screenshot of the color wheel with the hue quantize filter applied and the slider bar adjusted to a position between the far left and a middle position.

FIG. 18 shows a flow for the hue window filter.

FIG. 19 shows a screenshot of the color wheel with the hue window filter applied.

FIG. 20 shows a screenshot of the color wheel with the hue window filter applied and the slider bar adjusted to the far right.

FIG. 21 shows a screenshot of the color wheel with the hue window filter applied and the slider bar adjusted to the far left.

FIG. 22 shows a screenshot of the color wheel with the hue window filter applied and the slider bar adjusted to a position between a middle position and the far right.

FIG. 23 shows a screenshot of the color wheel with the hue window filter applied and the slider bar adjusted to a position between the far left and a middle position.

FIG. 24 shows a screenshot of a first portion of an advanced settings page.

FIG. 25 shows a screenshot of a second portion of the advanced settings page.

FIG. 26 shows a screenshot of a third portion of the advanced settings page.

FIG. 27 shows a screenshot of a fourth portion of the advanced settings page.

FIG. 28 shows a screenshot of a fifth portion of the advanced settings page.

FIG. 29 shows a screenshot of the color wheel with a hue quantize RG filter applied.

FIG. 30 shows a screenshot of the color wheel with a Daltonize filter applied.

FIG. 31 shows a screenshot of the color wheel with a max S filter applied.

FIG. 32 shows a screenshot of the color wheel with a max S and HQ filter applied.

FIG. 33 shows a screenshot of the color wheel with a max SV filter applied.

FIG. 34 shows a screenshot of the color wheel with an H->V filter applied.

FIG. 35 shows a block diagram of another specific implementation of an augmented reality system for color blindness.

### DETAILED DESCRIPTION

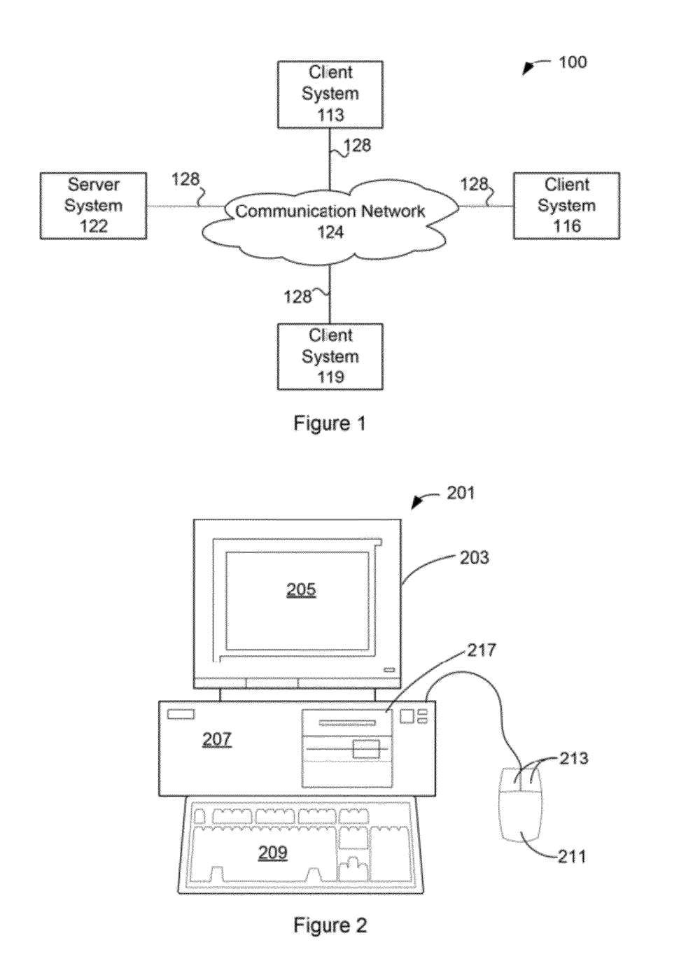

FIG. 1 is a simplified block diagram of a distributed computer network 100. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment and is not intended to limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both a client or a server depending on whether the computer system is requesting or providing information. Additionally, although aspects of the invention have been described using a client-server environment, it should be apparent that the invention may also be embodied in a stand-alone computer system. Aspects of the invention may be embodied using a client-server environment or a cloud-computing environment.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, a “Web browser” application executing on a client system enables users to select, access, retrieve, or query information stored by server system 122. Examples of web browsers include the Safari browser program provided by Apple, Inc., the Chrome browser program provided by Google, the Internet Explorer browser program provided by Microsoft Corporation, and the Firefox browser provided by Mozilla Foundation, and others.

FIG. 2 shows an exemplary client or server system. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD−R, DVD+R, DVD−RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium or non-transitory computer-readable medium or a computer product. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software may also be stored or reside on mass storage device 217 (e.g., hard disk, magnetic disk, tape, or CD-ROM). As a further example, code may be transmitted via wires, radio waves, or through a network such as the Internet.

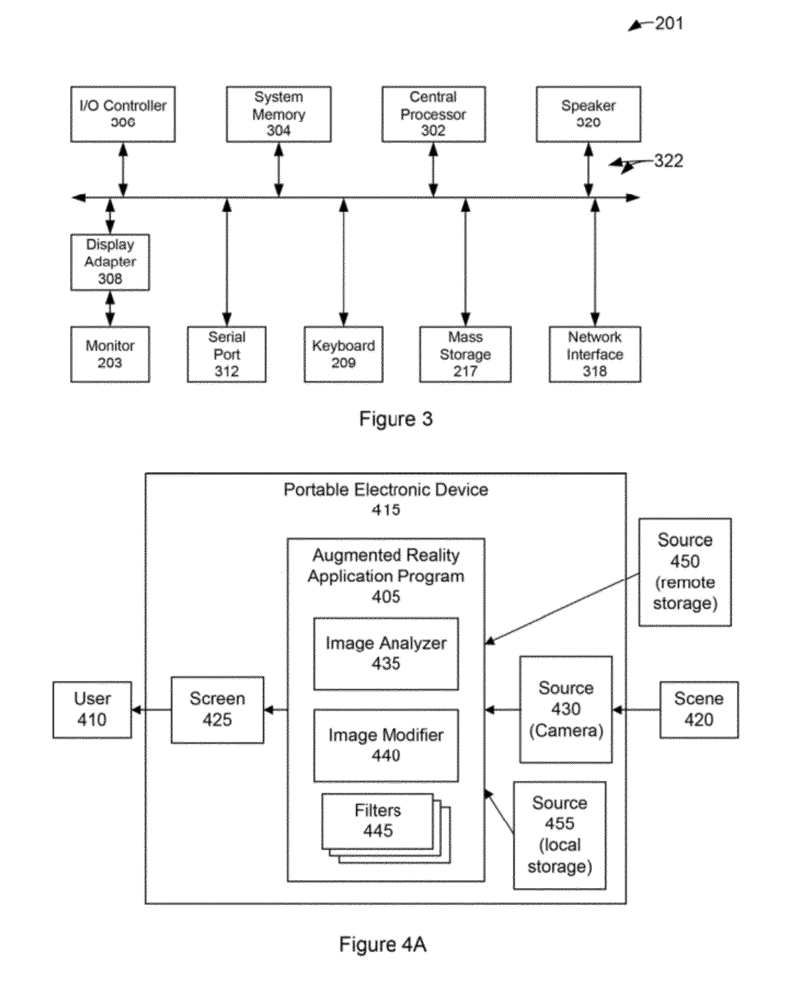

FIG. 3 shows a system block diagram of computer system 201. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. In an embodiment, a computer system includes additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a suitable computer system. Other configurations of subsystems suitable for use will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, Java, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation). In a specific embodiment, the present invention provides a computer program product which stores instructions such as computer code to program a computer to perform any of the processes or techniques described.

An operating system for the system may be iOS provided by Apple, Inc., Android provided by Google, one of the Microsoft Windows® family of operating systems (e.g., Windows 95, 98, Me, Windows NT, Windows 2000, Windows XP, Windows XP x64 Edition, Windows Vista, Windows 7, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, interne, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

It should be appreciated that the computers shown in FIG. 2-3 are merely exemplary. In a specific embodiment, the computer is a portable electronic device such as a smartphone or a tablet computer. The portable electronic device may include features such as a touchscreen, a camera, camera lens, multiple cameras (e.g., two or more cameras), video recorder, image sensor, flash, light, and so forth. A touchscreen is an electronic visual display that can detect the presence and location of a touch within a display area. With a touchscreen, a user may interact or provide input using finger or hand gestures or movements (e.g., tapping, swiping, pinching, flicking, pressing, sliding, pausing, or rotating). A touchscreen may also sense other objects such as a stylus.

The camera allows the portable electronic device to take pictures, record video, or both. For example, a smartphone may include a camera on one side of the device and a screen on an opposite side of the device. The user can use the camera by pointing the lens of the camera at a scene. A digital representation or image of the scene may then be displayed on the screen of the device. The screen may function as a viewfinder that allows the user to see a real-time view of the scene as the scene is being captured by the camera. Such a feature may be referred to as “live view.” The scene may include real-world physical objects such as clothing (e.g., shirts, ties, pants, dresses, or blouses), pictures, paintings, flowers, plants, fruit, signs (e.g., stop signs), colored lights (e.g., traffic lights, status lights, or warning lights), and so forth.

Some specific examples of smartphones include the iPhone provided by Apple, Inc., the HTC Wildfire S, EVO Design, and Sensation provided by HTC Corp., the Galaxy Nexus provided by Samsung, and many others. Some specific examples of tablet computers include the iPad provided by Apple, Inc., the Series 7 Slate provided by Samsung, and many others.

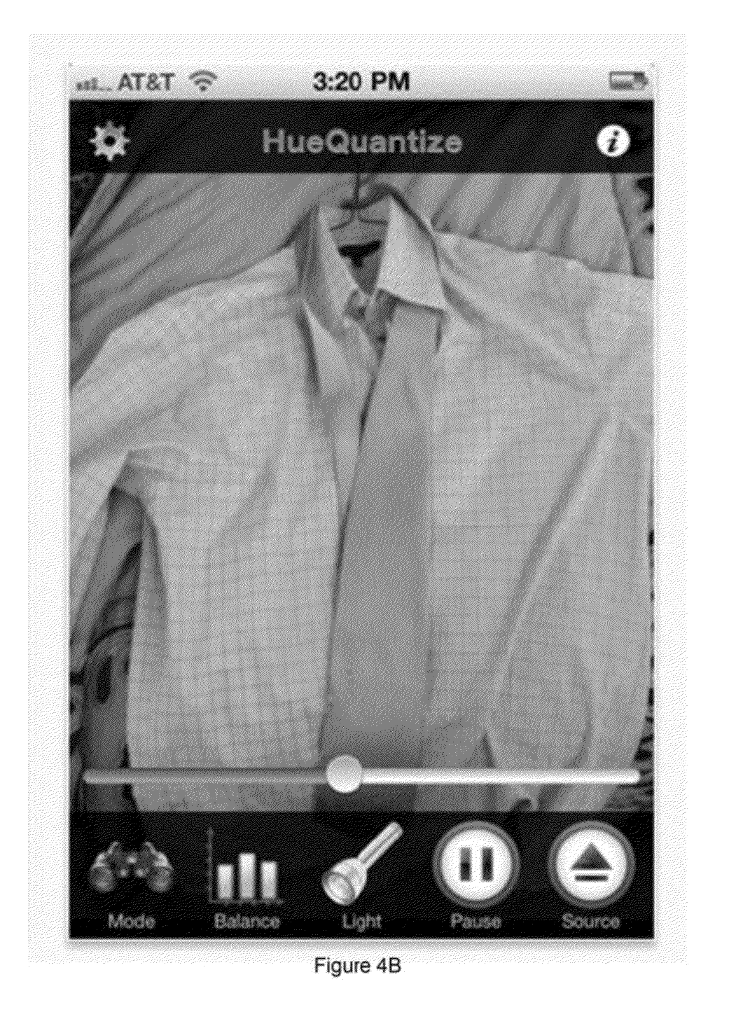

FIG. 4A shows a block diagram of a specific environment in which an augmented reality application program or tool 405 may be used. As shown in FIG. 4A, there is a user 410, a portable electronic device 415, and a scene 420. Device 415 may include a screen 425 and a camera 430.

In an embodiment, the user is color blind or has difficulty distinguishing colors. The user points the camera of the device at a scene. A digital representation or image of the scene that is to be displayed on the screen is altered by the tool. A color blind user viewing the altered image on the screen is able to perceive one or more colors present in the scene as the one or more colors would be perceived by a non-color blind person viewing the scene. For example, FIG. 4B shows a screenshot of a specific implementation of the tool where the tool has altered the image of a colored shirt so that the color blind person can perceive the actual color of the shirt.

Color blindness affects many millions of people. People having difficulty distinguishing colors may be prevented from certain occupations where color perception is an important part of the job or is important for safety. For example, people having color blindness may be prohibited from driving or piloting aircraft. Color blindness can also hamper a person's ability to choose matching clothes, correctly parse status lights on gadgets, manage parking structures, enjoy and appreciate art, movies, pictures, video, flowers, sunsets, landscapes, or pick ripened fruit—just to name a few examples. The augmented reality application or tool of the invention can help such people perceive, sense, distinguish, and differentiate colors in much the same way that a person without color blindness can perceive, sense, distinguish, and differentiate colors. In other words, the application can allow a person with color blindness to have a visual experience that is similar or substantially similar to a person without color blindness.

This patent application describes an augmented reality application, system, or tool in connection with a portable electronic device and, in particular, a smartphone or tablet computing device or machine. The augmented reality application may be executing or running on a smartphone or tablet. It should be appreciated, however, that the application may instead be implemented on a non-portable electronic device such as a desktop computer. Aspects and principles of the application may be implemented through or embodied in eye glasses or goggles, electronic display screens, windows, windshields, face shields, an image tracking system, a virtual reality system, a video system, or a head-mounted display (HDM)—just to name a few examples.

In a specific implementation, image processing occurs at the device, i.e., the device that captures the scene. In another specific implementation, at least a portion of image processing occurs at a remote machine such as at a server. Typically, servers have more computing capability than devices such as smartphone. In this specific implementation, information about the image captured by the device may be transmitted to the server for analysis such as over a network. The results of the analysis are returned from the server to the smartphone. Having some of the processing performed by the server may allow for a faster response time, a more comprehensive analysis, or both.

Referring now to FIG. 4A, in a specific implementation, augmented reality application program or tool 405 includes an image analyzer component 435, an image modifier component 440, and one or more filters 445. The image analyzer component is responsible for receiving an image from an input source such as camera 430. Other sources for images include, for example, local storage 455 or remote storage 450 (e.g., server).

In a specific implementation, the image is a digital representation of scene 420 or a real-world scene. In this specific implementation, the image includes a real-time or live video feed of the scene that may be streamed to and processed by the augmented reality program. The image may include multiple frames or a sequence of video frames. An image may include a picture, photograph, video or pre-recorded video, a moving picture, a two-dimensional digital representation of a stationary or moving object, or a three-dimensional digital representation of a stationary or moving object. The image may include an object having one or more colors. The object can be anything that is visible or is able to be captured by an image sensor of the device. As a specific example, the object can be an article of clothing such as a red or blue plaid shirt, a status indicator light (e.g., a light emitting diode (LED) indicator light), playing cards, cars, food, fruit, vegetables, flowers, other people, animals, fish, a movie playing on a movie screen, a television program playing on a television, or paintings—just to name a few examples.

Image modifier 440 alters the image by applying a user-specified filter to the image. The altered image is outputted to a display interface or output device such as screen 425. User 410 can look at the screen to view the altered image. By viewing the altered image, the user is able to see the color of an object in the image in a manner that is similar or substantially similar to the way that a person without color blindness can see the color of the object.

As an example, FIGS. 4B-8 show screenshots of a specific implementation of the augmented reality tool. In this specific implementation, the screenshots show images provided by the tool and displayed on an electronic screen of the portable electronic device to a user. This specific implementation of the tool or application program is called “DanKam: Colorblind Fix.” The title “DanKam” refers to the inventor, Dan Kaminsky. Mr. Kaminsky is known among computer security experts for his work on DNS cache poisoning (also known as “The Kaminsky Bug”). Mr. Kaminsky has been named by ICANN as one of the Trusted Community Representatives for the DNSSEC root.

DanKam is an iPhone app that displays video from the camera (among other sources), remixed so that it is a lot easier for the color blind to see colors, and the differences between colors, more accurately. The app is available on the App Store provided by Apple, Inc. DanKam has received glowing reviews for its ability to help people with color blindness see colors more accurately.

For example, some of the reviews and comments on the App Store include, “I am literally, almost in tears writing this, I CAN FRICKIN' SEE PROPER COLORS!!!!,” (emphasis in original), “Thank you so much for this app. It's like an early Christmas present! I, too, am a color blind Designer/Webmaster type with long-ago-dashed pilot dreams. I saw the story on Boing Boing, and immediately downloaded the app. My rods and cones are high-fiving each other. I ran into the other room to show a fellow designer, who just happened to be wearing the same ‘I heart Color’ t-shirt that you wore for the Forbes photo. How coincidental was that? Anyway, THANKS for the vision! Major kudos to you . . . ,” “Yellow is not green anymore! This app is amazing! I read the article on boingboing.com and could not tell the difference between the two green girl images. But for $2.99, I figured I'd give it a shot. After adjusting the settings to what I imagined would work fir [sic] me, I took an online ishahara test. I failed as usual without any aid, but passed with flying ‘colors’ when I filtered the test through the app,” “This is amazing! I've never been this excited in my entire life! I downloaded this and began looking at everything in my apartment. This could change my life! !”

It should be appreciated that a system of the invention may be known by any name or identifier, and this description is provided merely as a sample implementation. Screen elements including graphical user interface (GUI) controls may be modified or altered as appropriate for a particular application or use.

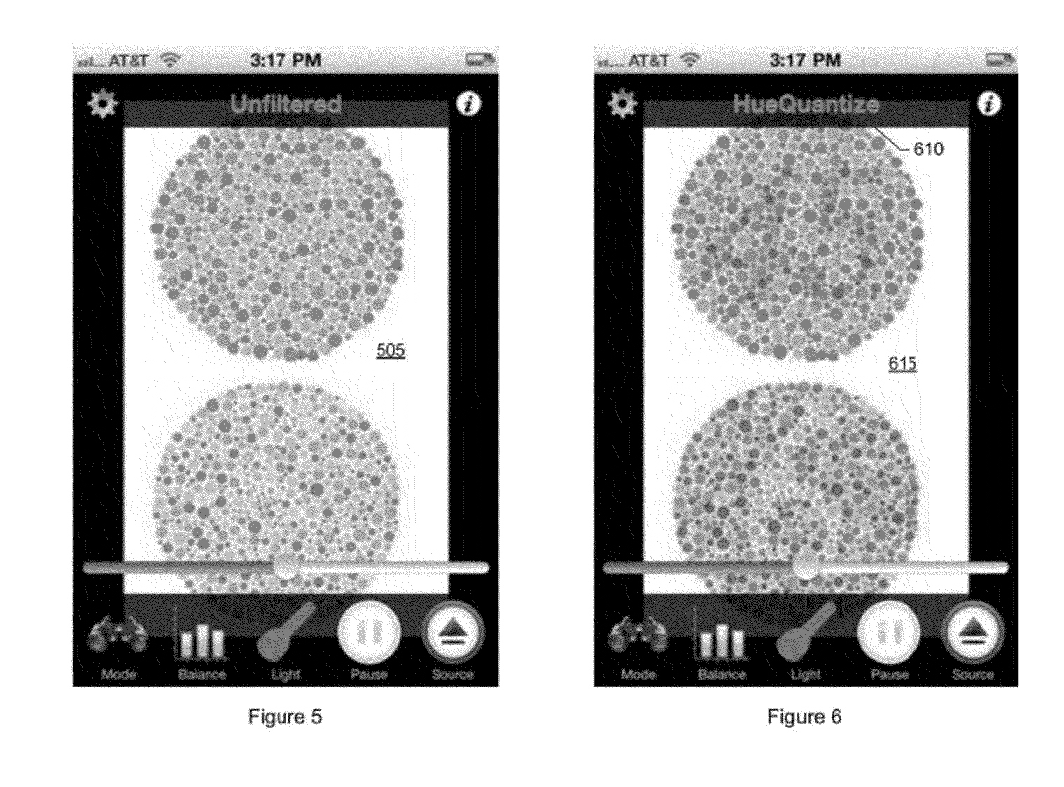

Referring now to FIG. 5, there is a screenshot of an Ishihara image 505 without a filter of the tool having been applied. That is, the tool is operating in an unfiltered mode. The Ishihara image includes patterns of dots in various colors and sizes, which are presented to the person being tested. Some of the dots form a number that is visible to a person with normal color vision, but is invisible or not visible to a person having a color deficiency. If the person does not recognize the number, the person being tested may have a problem with color recognition. The lack of color recognition is possible in various degrees and expressions. The most familiar expression is the red-green color deficiency.

For example, when viewing the screen shown in FIG. 5, a person with normal color vision will be able to see the number “45” in the top circle and the number “6” in the bottom circle. A person with a color deficiency, however, will not be able to see the numbers.

FIG. 6 shows a screenshot of the Ishihara image after a filter 610 of the tool has been applied to provide an altered image 615. Filter 610 may be referred to as the “HueQuantize” filter or mode. After the filter has been applied, the person with the color deficiency may be able to see the numbers “45” and “6.”

In a specific implementation, the tool includes multiple filters (i.e., two or more filters). Each filter may include one or more particular color adjustment parameters or settings that will alter the image in a particular way. The degree, type, and form of color blindness can vary among color blind individuals. An adjustment to a particular color parameter may allow some individuals to see a color, but not other individuals. An adjustment, however, to a different color parameter may allow the other individuals to see the color. Thus, having multiple filters allows the individual to select a particular filter that provides desirable results.

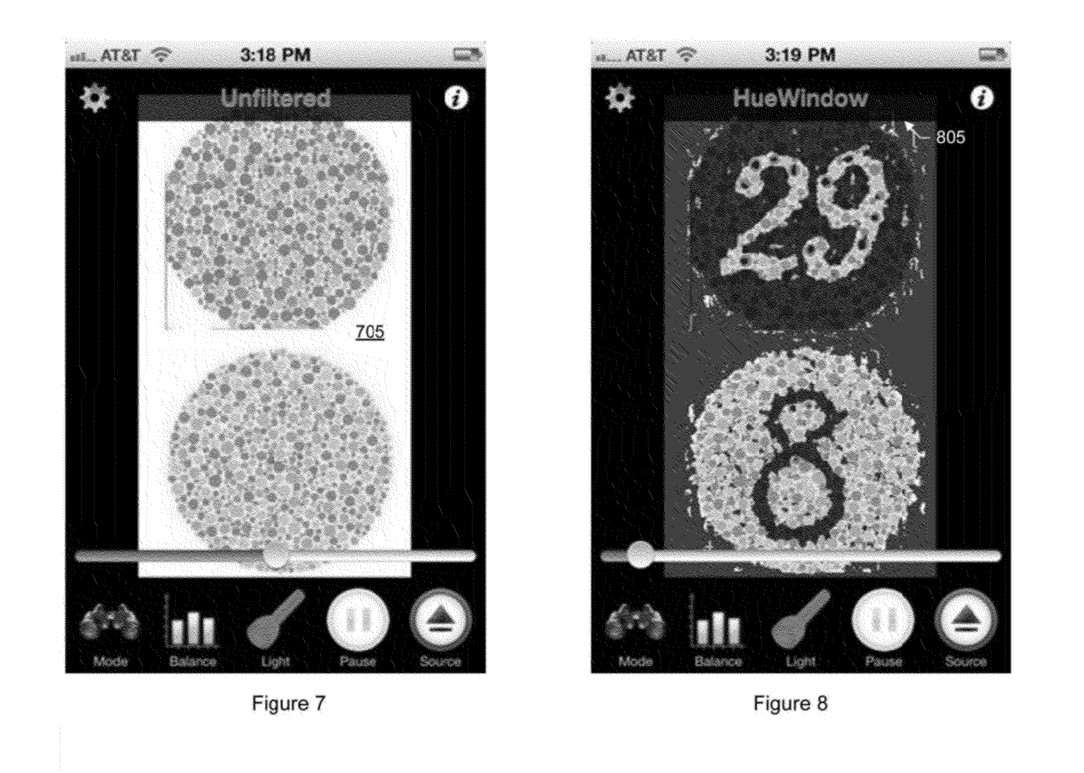

For example, FIGS. 7-8 show screenshots of a different Ishihara image where a different filter 805 (FIG. 8) has been applied. More particularly, FIG. 7 shows a screenshot of an Ishihara image 705 without a filter having been applied. A person with normal color vision will be able to see the number “29” in the top circle and the number “8” in the bottom circle. A person with a color deficiency will not be able to see the numbers. FIG. 8 shows a screen shot of the Ishihara image having been altered by filter 805. After the alteration, when viewing the altered image on the screen, the person with the color deficiency may be able to see the numbers “29” and “8.” Filter 805 may be referred to as the “HueWindow” filter or mode.

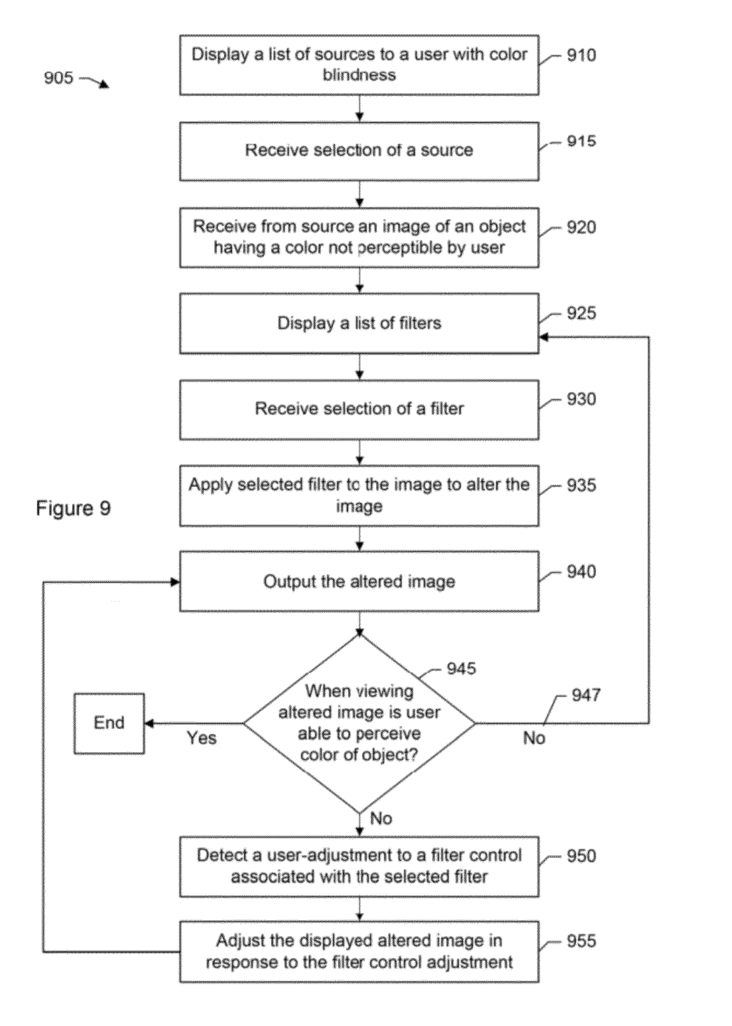

FIG. 9 shows an overall flow 905 for using the tool. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other implementations may not be exactly the same as the steps presented and may be modified or altered as appropriate for a particular process, application or based on the data.

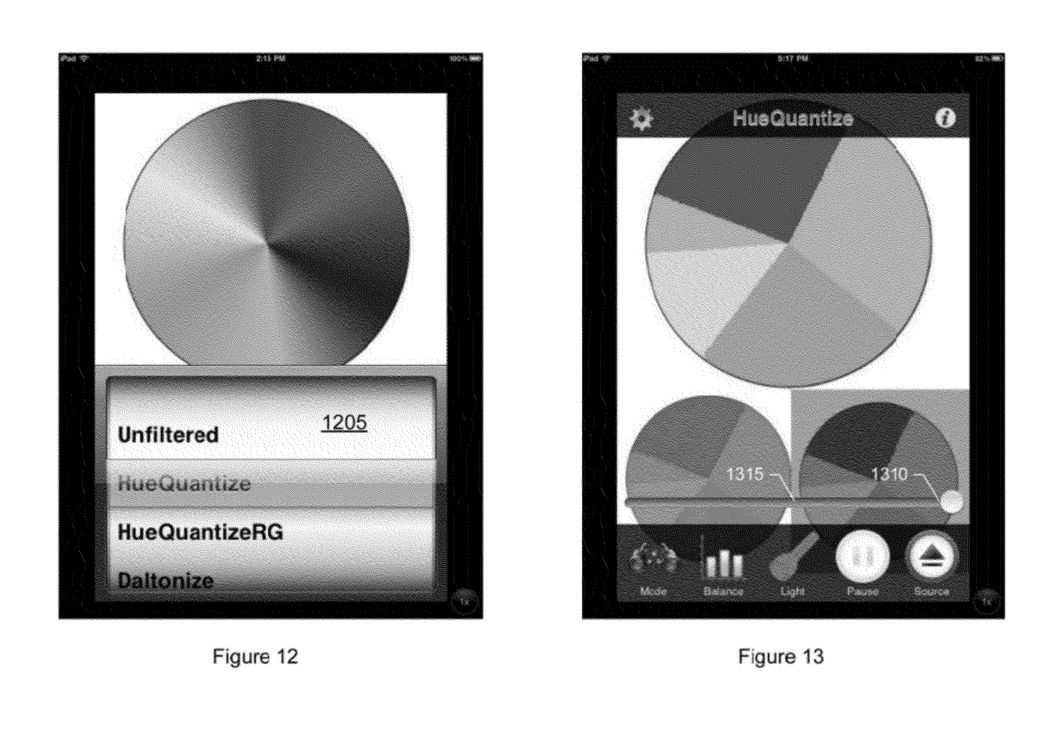

In a step 910, the tool provides a user with an option to select a source from a list of sources. The user may be a person with color blindness. The list allows the user to select an input device or identify the source that will provide the image to be altered by the tool. The list may include any number of sources. In a specific implementation, the list includes six sources, but there can be any number of sources including, for example, less than six sources (e.g., one, two, three, four, or five sources) or more than six sources (e.g., seven, eight, nine, or more than nine sources). See, e.g., FIG. 12.

In a specific embodiment the tool is implemented in connection with a portable electronic device having camera such as a back camera on a side of the device opposite a side having a screen of the device. The back camera may be a first source in the source list. The device may further include a front camera that is on the same side as the screen of the device. The front camera may be presented in the list as a second source. This specific embodiment includes third, fourth, fifth, and sixth sources listed in the source list. The third source includes an Ishihara test image. The fourth source includes another Ishihara test image. The fifth source includes a color wheel. The sixth source includes a library. It should be appreciated that the sources may be arranged in any order.

Including the Ishihara test images allows the user to test whether or not they are color blind. For example, many people may not be aware that they are color blind. Including the Ishihara test images with the tool provides a convenient way for the user to test their color perception. That is, the user can view the test images in an unfiltered mode (see e.g., FIGS. 5 and 7). If the user is able to see the numbers in the test images, the user may not have a color deficiency. If, however, the user is unable to see the numbers in the test images, the user may have a color deficiency.

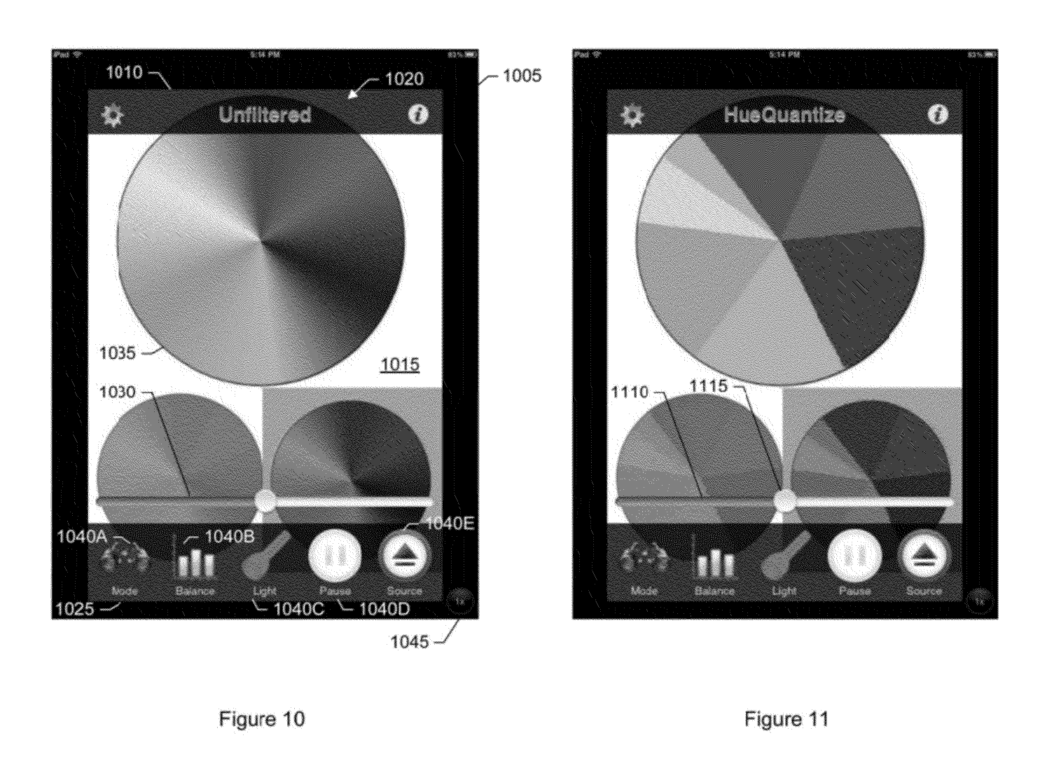

The tool allows the user to select a filter to apply to the test image (see e.g., FIGS. 6 and 8). This allows the user to determine whether or not the tool will work for them. That is, if the user is able to see the numbers in the test images after applying a filter the application may be able to assist the user with their color deficiency. The color wheel allows the user to see the result of the various filters or to see how the filters work. For example, FIG. 10 shows a color wheel without a filter having been applied. FIG. 11 shows the color wheel with the HueQuantize filter applied.

By selecting the library as the source, the user can select, for example, a stored picture or video. The picture or video may be stored locally at the portable electronic device. Alternatively, the picture or video may be stored remotely from the device such as at a server or other remote data repository. In a specific implementation the user can input an address such as a uniform resource identifier (URI) or uniform resource locator (URL) that identifies the remote source location where the picture or video may be stored.

In a step 915, the tool receives a user-selection of a source. In a step 920, the tool receives from the source an image. For example, if the user identifies the source as being the camera, the scene facing the camera can be projected on the electronic screen of the device. The image formed by the camera lens can be continuously projected or fed to the electronic screen so that the user is viewing the scene in real-time. The image may include an object having a color that may not be perceptible by the user.

For example, a person with protanopia or deuteranopia may have difficulty with discriminating red and green hues. A person with tritanopia may have difficulty discriminating blueish versus yellowish hues. Certain reds might look like they were green. Certain greens might look like they were red. As a specific example, a person with a color deficiency may see a green colored object as tan.

In a step 925, the tool provides the user with an option to view a list of filters. The filter list allows the user to select a desired filter which when applied to the image will alter one or more color parameters of the image. In a specific implementation, there are eight filters, but there can be any number of filters. There can be more than eight filters such as nine, ten, or more than ten filters. There can be less than eight filters, such as one, two, three, or four filters.

Having multiple filters, such as two or more filters, allows the user to test through trial and error each of the different filters to find that filter which provides desirable results given factors such as the user's particular color deficiency, ambient light conditions, the scene being viewed, the capabilities of the device screen, and so forth. The graphical user interface allows the user to quickly flip between a number of filter modes so that the user can find a filter mode that provides desirable results. In a specific implementation, the tool permits the user to select a single filter to apply. In another specific implementation, the tool permits the user to select two or more filters to apply.

In a step 930, the tool receives a user-selection of a filter. In a step 935, the tool applies the selected filter to the image to alter the image. Altering the image may include altering one or more color parameter values. A color parameter refers a particular aspect, property, component, or dimension of color. More particularly, color can be described using a color space or color model that provides a mathematical representation of colors. In a specific embodiment, the color model is the Hue, Saturation, Value (HSV) color model. Variants of the HSV color model include the Hue, Saturation, Brightness (HSB) color model and the Hue, Saturation, and Lightness (HSL) color model. Other embodiments may include a different color model.

In the HSV color model, color is separated into three parameters or dimensions including hue, saturation, and value. The HSV color model is sometimes represented as a cylinder. A center axis passes through the cylinder, from white at the top of the cylinder to black at the bottom of the cylinder, with other neutral colors in between. The angle around the central axis corresponds to the Hue (H). Hue defines the color and may range, for example, from 0 degrees to 360 degrees. Generally, as one moves around the central axis, there is a gradation of colors. That is, there is a gradual and progressive color change from one color or tone to another. For example, 0 degrees may correspond to the color red, 45 degrees may correspond to the color yellow, 55 degrees may be a shade of yellow, and so forth.

A distance from the central axis corresponds to saturation (S). Saturation defines the intensity of the color and may range, for example, from 0 percent to 100 percent where 0 percent corresponds to no color (e.g., a shade of gray between black and white) and 100 percent corresponds to an intense color. A distance along the axis corresponds to the value (V). Value defines the brightness of the color and may range, for example, from 0 percent to 100 percent where 0 corresponds to black and 100 corresponds to white. It should be appreciated that the HSV parameter values may be expressed using any mathematical form such as by a number, real number, integer, rational number, decimal representation, ratio, and so forth. Numbers may be scaled such as on a scale from 0 to 32 or from 0 to 1.

Altering a color parameter may include changing a value of a color parameter from an original or “true” value to a different or new value. Altering a color parameter may include any mathematical operation including, for example, addition, multiplication, division, subtraction, averaging, or combinations of these. A value of a color parameter may be set to a new value which may be greater than or less than the original or “true” value of the color parameter. A value of a color parameter may be scaled. A number may be added to the color parameter value. The color parameter value may be divided by a number. The color parameter value may be multiplied by a number. A number may be subtracted from the color parameter value. The number may be a predetermined number.

Altering a color parameter may include changing a single color parameter and not changing other color parameters. For example, in a specific implementation, the hue color parameter is changed and the saturation and value color parameters are not be changed. In this specific implementation, saturation and value are left alone and only hue is quantized. Alternatively, two or more color parameters may be changed. For example, the hue and the saturation color parameters may be changed.

In a step 940, the tool outputs or emits the altered image. In a specific implementation, the altered image is outputted onto the screen of the portable electronic device. The altered image may instead or additionally be outputted to a printer so that a physical print out of the altered image can be made on paper, outputted to a screen of another electronic device, or both.

The altered image can allow the user, when viewing the altered image, to perceive the color of the object as the color would be perceived by a non-color blind person viewing the object. For example, the color blind person when viewing the altered image having a digital representation of the object may have the same, similar, or substantially similar visual experience as would a non-color blind person viewing the unaltered image or viewing the physical object.

In a specific implementation, the altered image does not include text indicating the color or a recorded or synthesized voice that speaks the color. Rather, the color blind person is able or substantially able experience a sensation of color that may come from nerve cells that send messages to the brain about the brightness of color, greenness versus redness, or blueness versus yellowness. That is, the tool can trigger the visual sensation or experience that comes from seeing color. In another specific implementation, the altered image includes text indicating the color, a voice that speaks the color, or both. A legend may be displayed including text which indicates identifies one or more colors as viewed through a particular filter.

In a specific implementation, the tool provides options for the user to further alter the image, select different filter, or both. For example, if the user is not able to perceive the color of the object, the user can select a different filter to apply (see step 945 and arrow 947). In a specific implementation, the selection of the different filter replaces the filter originally selected. In another specific implementation, the selected different filter is added to the filter previously selected. In a specific implementation, the tool instead or additionally includes a filter adjustment control which the user can use to adjust the altered image. In this specific implementation, the control alters one or more settings of a filter in a filter dependent way. For example, in a step 950, the tool may detect a user-adjustment to the filter control associated with the selected filter. In a step 955, the tool adjusts the displayed altered image in response to the filter control adjustment.

In a specific implementation, a technique for augmented reality for color blindness includes: I) Frame capture/acquisition of a scene; 2) Filtration; and 3) Emission. In this specific implementation, images are captured in RGB. The filtration process includes determining a true value or color of an object and changing the color or altering the output of what is seen. In some embodiments a Red, Green, Blue (RGB) color space is converted or transformed into an HSV color space and the image is analyzed in the HSV color space. One or more of the hue, saturation, and value components for each pixel may receive a value (e.g., ranging from 0-255). Analysis may be on a per pixel basis and include a white balancing. Colors may be filtered into anomalous trichromats.

An analysis of a scene may include object recognition to find or define one or more objects in the scene. This helps in separating the object and the surrounding or ambient light. Any competent technique or model may be used for object recognition including, for example, grouping, Marr, Mohan and Nevatia, Lowe, and Faugeras object recognition theories, Binford (generalized cylinders), Biederman (geons), Dickinson, Forsyth and Ponce object recognition theories, edge detection or matching, divide-and-conquer search, greyscale matching, gradient matching, large modelbases, interpretation trees, hypothesize and test, pose consistency, pose clustering, invariance, geometric hashing, scale-invariant feature transform (SIFT), speeded up robust features (SURF), template matching, gradient histograms, intraclass transfer learning, explicit and implicit 3D object models, global scene representations, shading, reflectance, texture, grammars, topic models, biologically inspired object recognition, and many others.

In a specific implementation, having determined the object colors, the tool emits or re-emits those colors in a way that the viewer can correctly see those particular colors. Generally, most color blind people have a color they see as red, a color they see as green, and so forth. In a specific implementation, the tool makes all objects perceived as red or a shade or type of red the same red, all objects perceived as green or a shade or type of green the same green, and so forth. Reds may be made more red by making them pinker (e.g., increasing the blue signal). Greens may be made more green by reducing the red signal, increasing the blue signal, or both.

Referring now to FIG. 10, in a specific implementation the augmented reality application program or tool provides graphics that are shown on a screen 1005 of the device. There may be a window 1010 including a display region 1015, a title bar 1020, a bottom icon bar 1025, and a slider or tuner 1030. As shown in the example of FIG. 10, there is an image of an object (e.g., a color wheel 1035) being displayed within the display region. The bottom icon bar includes a set of icons or buttons including first, second, third, fourth, and fifth buttons 1040A-E.

The title bar identifies the current filter, mode, or filter mode, if any, that currently in use. In this example, no filter has been applied. Thus, the title bar includes the phrase “Unfiltered” to indicate that the image is not being filtered.

Button 1040A may be referred to as a mode or filter list. To access the filter list, the user can select button 1040A. In response to the user-command, the tool displays a list of filters 1205 as shown in FIG. 12. The filter list is overlaid on the image. The user can scroll through the list of filters and make a selection of the desired filter (e.g., HueQuantize). After the user selects the desired filter, the tool applies the filter to the image to alter image.

For example, FIG. 11 shows the HueQuantize filter having been applied to the color wheel image to alter the image. The user can make adjustments to the filter setting through the slider 1110. For example, if the color of the object is not perceptible after applying the filter, the user can adjust the filter setting using the slider. The user can move a slider indicator 1115 from a first position 1315 to a second position 1310 (see FIG. 13). As shown in FIG. 13, the user has repositioned the slider indicator to a far right-hand side of the screen. Based on the slider indicator position, the tool responds accordingly to adjust the image.

In this specific implementation, the slider is displayed near a bottom of the screen. The slider is closer to the bottom of the screen than a top of the screen. The slider is positioned horizontally or parallel with the bottom edge of the screen. This allows the user to access the slider using the same hand used to hold the portable electronic device (e.g., smartphone). It should be appreciated, however, that the slider may be positioned at any location on the screen or may be oriented differently from what is shown (e.g., oriented vertically).

In a specific implementation, the slider is displayed persistently on the screen. For example, after the slider indicator is moved to the second position, the slider will remain or continue to be displayed on the screen. This allows the user to quickly and easily make on-the-fly adjustments by, for example, sliding the slider indicator back and forth. In another specific implementation, the slider may be hidden to allow a greater unimpeded viewing area for the image.

The specific graphical user interface (GUI) elements shown in the Figures are merely exemplary. It should be appreciated that there can be other GUI elements that can replace the GUI elements shown or that can be in addition to the GUI elements shown. For example, there can be buttons, text boxes, radio buttons, pulldown menus, checkboxes, switches, selectors, list boxes, notification boxes, a keyboard, number pad, or combinations of these. In a specific implementation, the tool receives user commands through hand gestures. In another specific implementation, the tool instead or additionally can receive commands through voice. For example, the tool may be configured or adapted for voice-recognition.

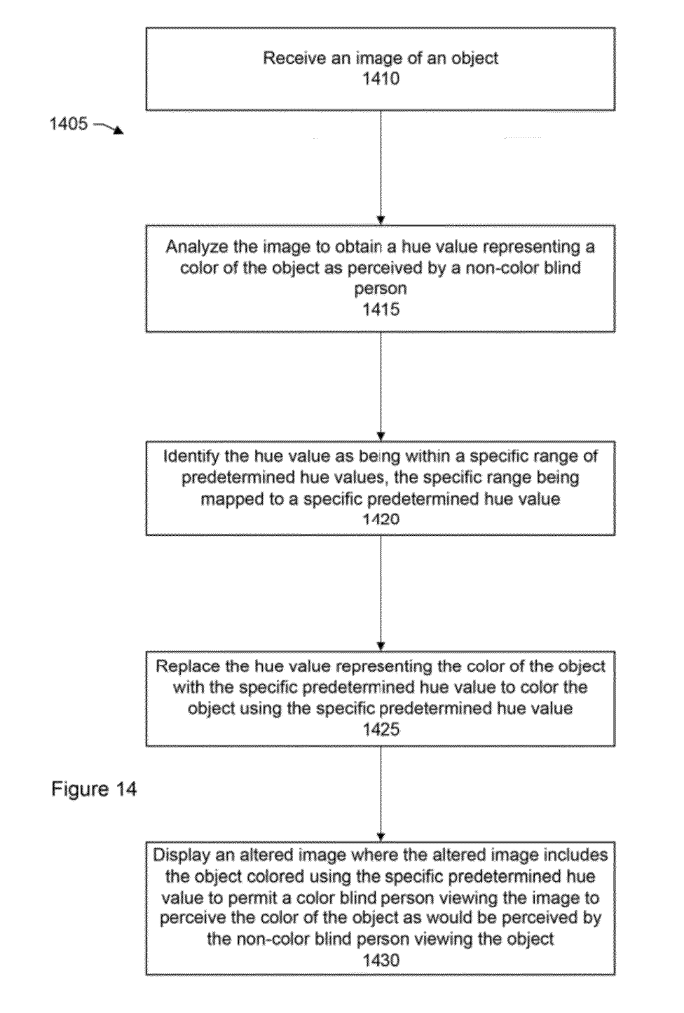

As discussed above, the tool may include any number of filters. Each filter may alter one or more color parameters differently from another filter. FIG. 14 shows a flow 1405 of the processing for a specific filter that may be referred to as the HueQuantize filter.

In this specific implementation, a filter technique includes canonicalizing H or hue. That is, all colors within a range of possible subhues are made a canonical value. For example, on a scale from 0 to 32, a hue of 1.0 (an imperceptibly orange red) is made a flat red.

Referring to FIG. 14, in brief, in a step 1410 the tool receives an image of an object. In a step 1415, the tool analyzes the image to obtain a hue value representing a color of the object as perceived by a non-color blind person. That is, the image is processed to extract or determine a value for the color parameter hue.

In a step 1420, the tool identifies the hue value as being within a specific range of predetermined hue values, where the specific range has been mapped to a specific predetermined hue value. In a step 1425, the tool replaces, switches, or substitutes the hue value representing the color of the object with the specific pre-determined hue value to color the object (or the digital representation of the object) using the specific pre-determined hue value. That is, to color the object with a color corresponding to the specific pre-determined hue value. In a step 1430, the tool displays an altered image. The altered image includes the object colored using the specific predetermined hue value. This may permit a color blind person viewing the altered image to perceive the color of the object as would be perceived by the non-color blind person viewing the object.

More particularly, in a specific implementation, there is a set of hue value ranges. Each range may include a lower limit, an upper limit, or both. Each range is mapped to or associated with a specific hue value. In this specific implementation, the tool extracts, calculates, or otherwise determines the hue value of the object. The hue value is compared with one or more of the hue value ranges to identify the particular range within which the hue value falls. For example, given a first hue value range, the tool may determine whether the hue value is between a lower and upper limit of the first hue value range. If, for example, the hue value is not within the lower and upper limits of the first hue value range (e.g., the hue value is greater than the upper limit of the first hue value range), the tool may examine a second hue value range to determine whether the hue value falls between a lower and upper limit of the second hue value range, and so forth.

Once the specific hue value range is identified, the tool uses the corresponding hue value mapped to the specific hue value range to color the object, i.e., the digital representation of the object. Thus, multiple hue values may be mapped to a single hue value. For example, light reds, dark reds, orange-reds, and the like may each map to a single red. In other words, in this specific implementation, upon applying the hue quantize filter there are no longer any color gradations. As an example, compare the color wheels shown in FIG. 10 with the filtered or altered color wheel shown in FIG. 11. In FIG. 10, as one moves around the color wheel, there is a gradual and progressive change in the colors. In FIG. 11, the HueQuantize filter has been applied to the color wheel which has resulted in a “chunking” or “bucketing” of the color gradations. In other words, there are defined boundaries between the different colors rather than there being a gradation between two different colors.

Table A below identifies the set of hue value ranges, the specific hue value or target hue value that a range is mapped to, and a corresponding color name as implemented in a specific embodiment. In this specific implementation, the hue values are on a scale from 0 to 32. In another specific implementation, the scale is from 0 to 1. It should be appreciated, however, that any scale or scaling factor can be used to scale the hue values up or down.

TABLE A

| Hue Value Range | Target Hue Value | Color |
|---|---|---|
| 0 to 3.75 | 30.2 | Red |
| 3.75 to 5.25 | 3.6 | Orange |
| 5.25 to 7.5 | 6.2 | Yellow |
| 7.5 to 12.5 | 12.5 | Green |
| 12.5 to 18.0 | 15.8 | Cyan |
| 18.0 to 24.0 | 20.0 | Blue |
| 24.0 to 30.0 | 26.3 | Magenta |

These ranges for quantizing hues were developed by studying people with color deficiencies. Experiments were conducted in which images were altered in various different ways and then shown to people with color deficiencies. The experiments and results of the experiments were collected in a database. A statistical analysis was performed which identified these ranges and mappings as providing desirable results.

As shown in Table A above, in a specific implementation, the target hue value may be outside the range or predetermined range of hue values (e.g., the target hue value of 30.2 for “red” is outside the corresponding range of hue values 0 to 3.75). The target hue value may be within the range of hue values (e.g., the target hue value of 6.2 for “yellow” is within the corresponding range of hue values 5.25 to 7.5). The target hue value may be less than the lower limit of the corresponding range of hue values (e.g., the target hue value of 3.6 for “orange” is less than the lower limit of 3.75 for the corresponding range of hue values 3.75 to 5.25).

The target hue value may be greater than the upper limit of the corresponding range of hue values (e.g., the target hue value of 30.2 for “red” is greater than the upper limit of 3.75 for the corresponding range of hue values 0 to 3.75). In this specific implementation, in some cases the target hue value is much greater than the upper limit of the corresponding hue value range. For example, the target hue value of 30.2 for “red” is about 8 times greater than the upper limit of 3.75 for the corresponding range of hue values 0 to 3.75. The target hue value may be equal to a lower limit or upper limit of the corresponding hue value range (e.g., the target hue value of 12.5 for “green” is equal to the upper limit of 12.5 for the corresponding range of hue values 7.5 to 12.5).

As discussed above, in a specific implementation, the tool allows the user to adjust one or more of the ranges. For example, by using the slider, the user can increase or decrease a range. For example, the user may increase or decrease a lower limit of a range, increase or decrease an upper limit of a range, or both. In a specific implementation, these settings are saved in a user profile that may be stored locally at the device, at a location remote from the device, or both. Storing the settings in a user profile can help to ensure that the user does not have to readjust the filter each time the filter is used.

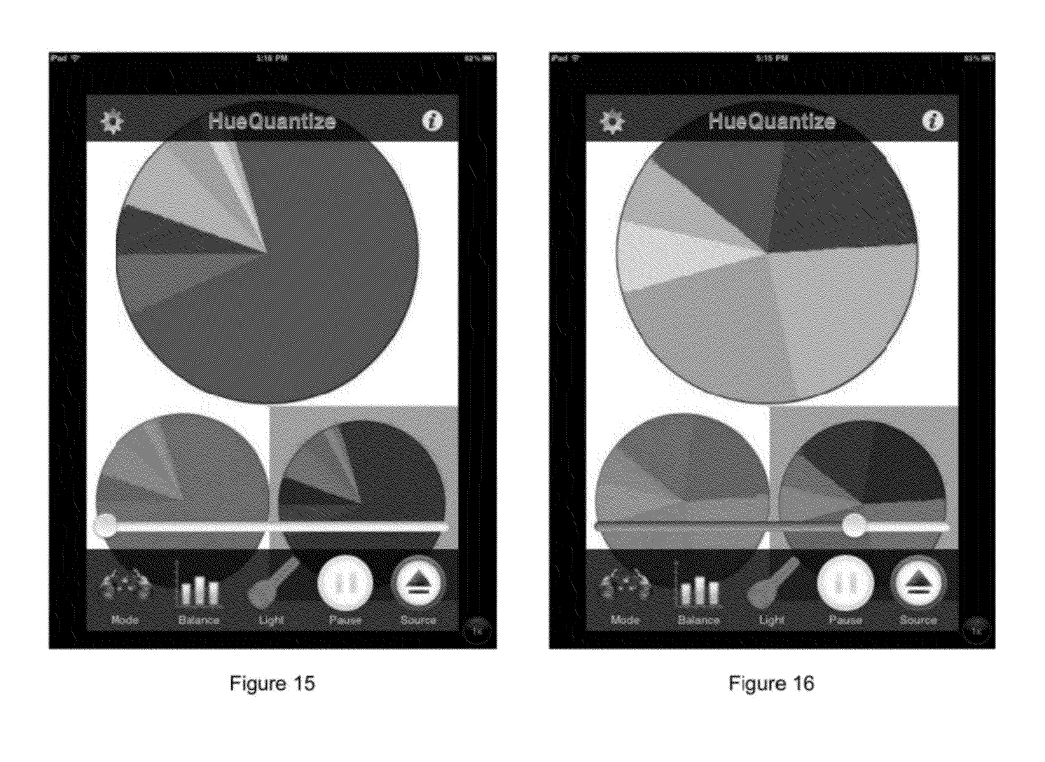

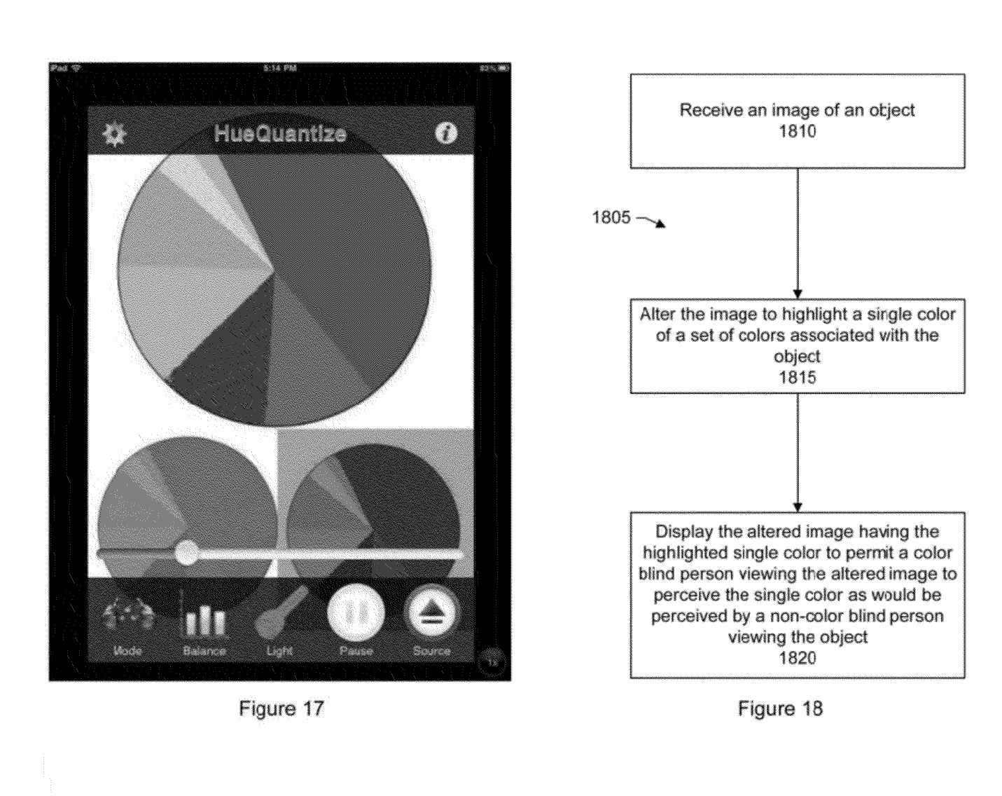

As an example, FIGS. 13 and 15-17 show some examples where the user has moved or repositioned the slider associated with the hue quantize filter to adjust the altered or filtered image. FIG. 13 shows a screenshot where the color wheel image has been adjusted in response to the slider being moved to the far right-hand side. FIG. 15 shows a screenshot where the color wheel image has been adjusted in response to the slider being moved to the far left-hand side. FIG. 16 shows a screenshot where the color wheel image has been adjusted in response to the slider being moved to a point or position between the far right-hand side and the default or middle position. FIG. 17 shows a screenshot where the color wheel image has been adjusted in response to the slider being moved to a point or position between the far left-hand side and the default or middle position.

FIG. 18 shows a flow 1805 of the processing of another specific filter that may be referred to as the HueWindow filter. In a step 1810, the tool receives an image of an object. In a step 1815, the tool alters the image to highlight a single color of a set of colors associated with the object. In a step 1820, the tool displays the altered image having the highlighted single color to permit a color blind person viewing the altered image to perceive the single color as would be perceived by a non-color blind person viewing the object.

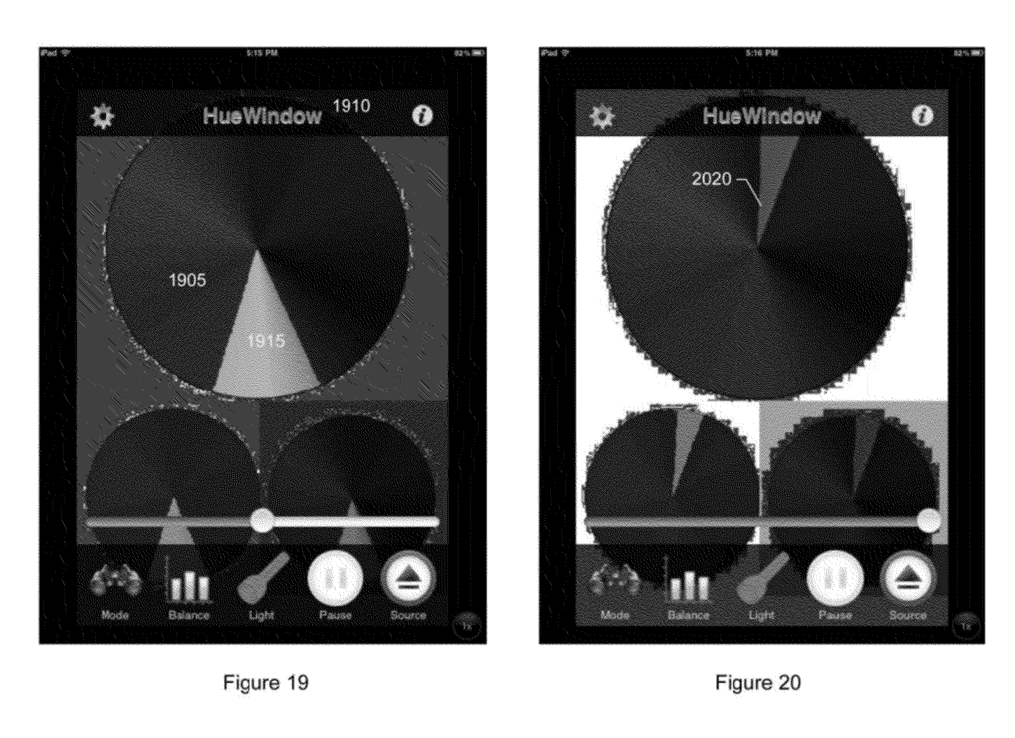

As an example, FIG. 19 shows an image of a color wheel object 1905. In this example, a HueWindow filter 1910 has been applied to the image to alter the image. Specifically, a color 1915 (e.g., cyan) has been highlighted or emphasized. The user can use the slider bar to change what color is highlighted. Research has shown that in some cases, a color blind user is able to perceive a specific color of an object after other colors have been removed or darkened.

In a specific implementation, the HueWindow filter limits or reduces the number of colors that are shown. In another specific implementation, the HueWindow filter limits the number of colors shown to a single color. In another specific implementation, the HueWindow filter highlights a single color. Highlighting a color may include changing one or more color parameters of the color while other the color parameters of other colors remain unchanged or are not changed. Highlighting a color may include changing one or more color parameters of the color and changing the color parameters of one or more other colors. Highlighting a color may include changing one or more color parameters of one or more other colors while the color parameters of the color to be highlighted remains unchanged or not changed.

As discussed above, each filter may include a slider that allows the user to further adjust one or more settings of a particular filter. For example, FIG. 20 shows an example where the slider associated with the hue window filter has been adjusted to the far right-hand side. The user can use the slider to sweep a window slice 2020 about the color wheel to a particular color on the color wheel that the user would like to highlight. That is, the user can sweep the wheel around to indicate, for example, that green is to be highlighted, that blue is to be highlighted, that purple is to be highlighted, that yellow is to be highlighted, that red is to be highlighted, and so forth. The hue window mode allows the user to select a small “slice” of the color spectrum—just the blues, for example, or just the greens.

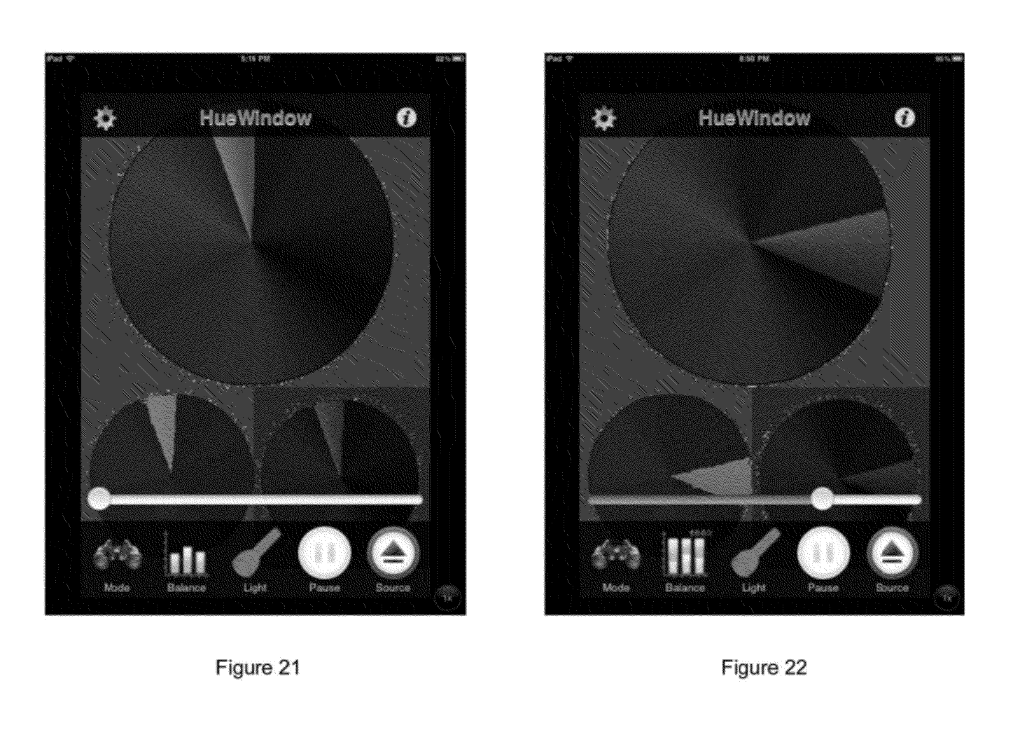

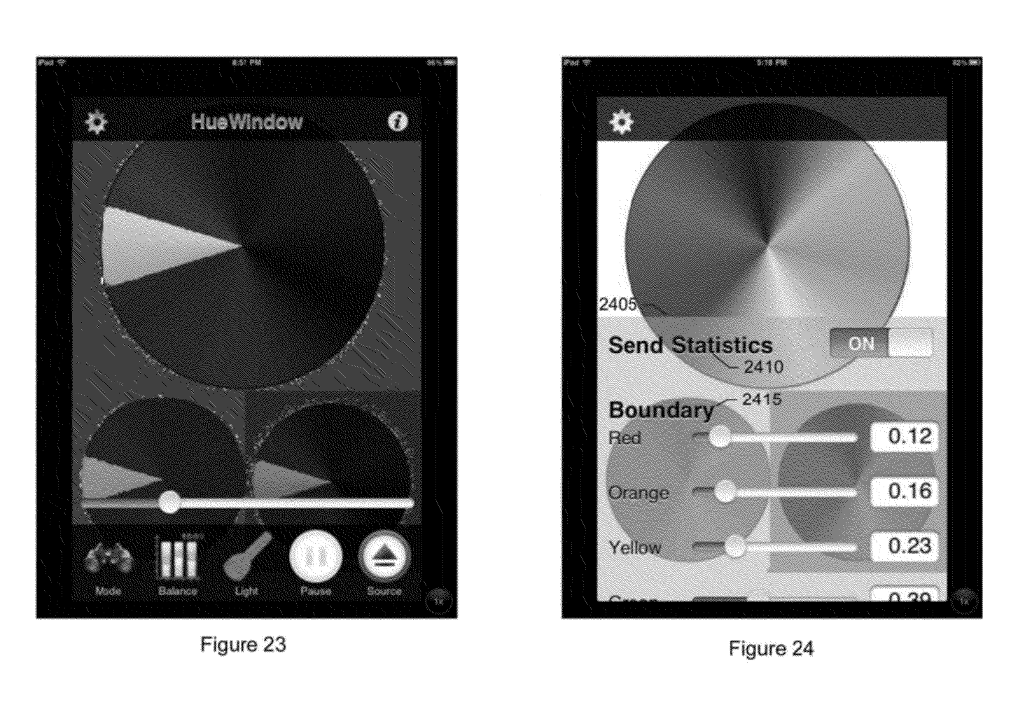

FIG. 21 shows a screenshot of the resulting color wheel image adjustment when the slider indicator is positioned at a far left-hand side of the slider bar. FIG. 22 shows a screenshot of the resulting color wheel image adjustment when the slider indicator is between a middle position and a far right-hand side of the slider bar. FIG. 23 shows a screenshot of the resulting color wheel image adjustment when the slider indicator is between a middle position and a far left-hand side of the slider bar.

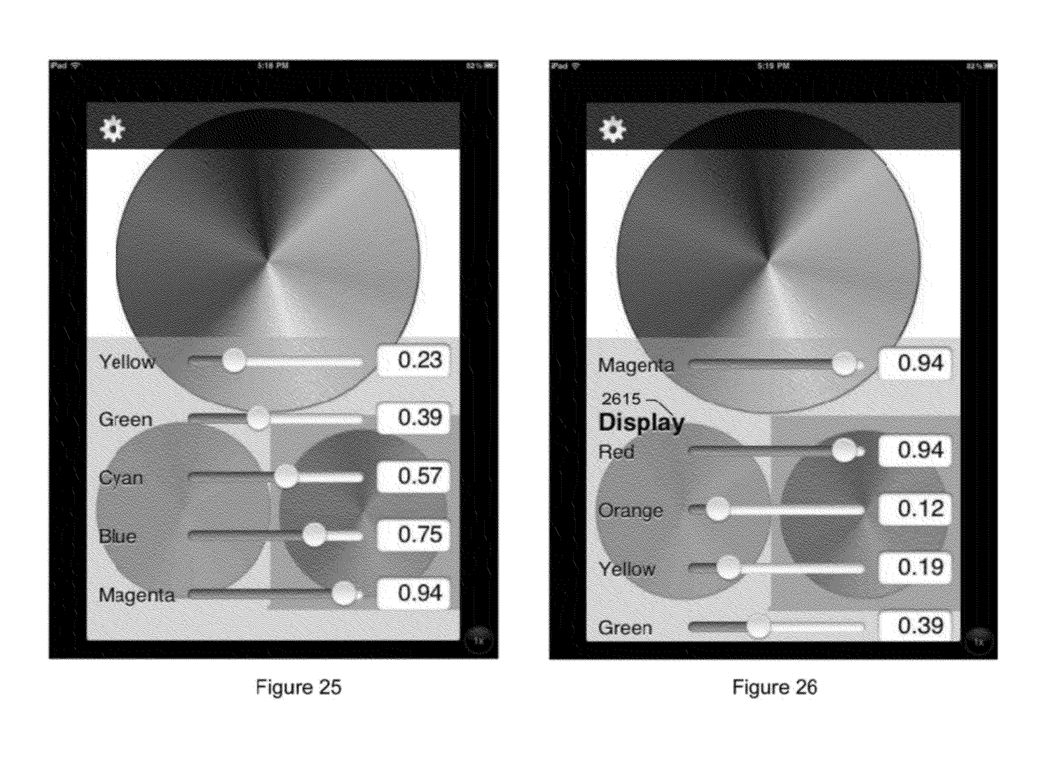

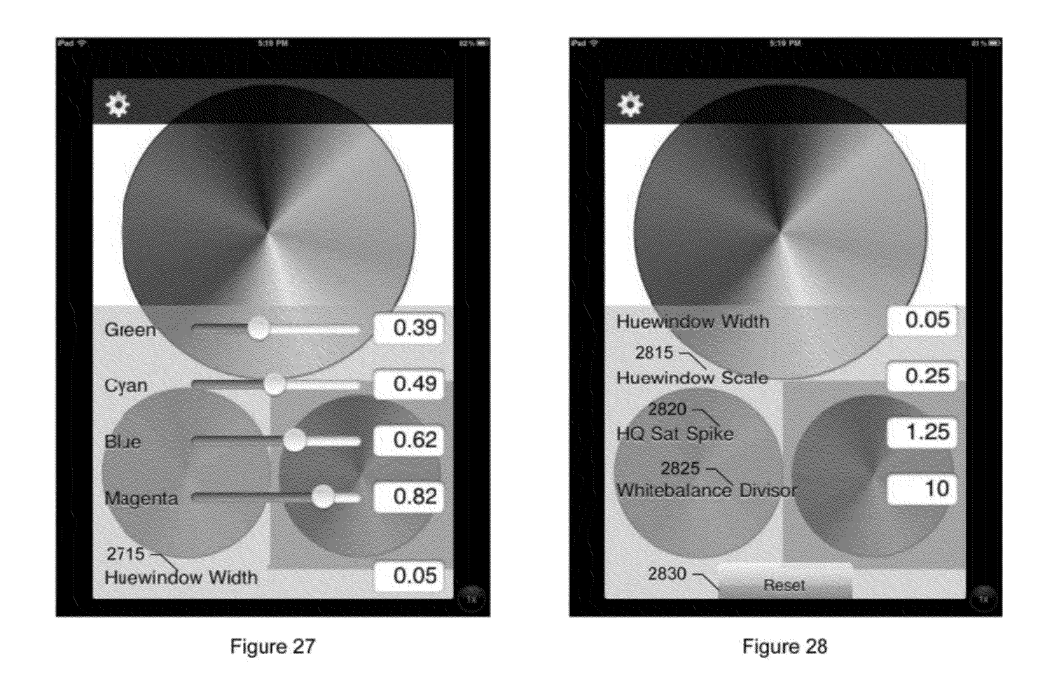

FIGS. 24-28 shows screenshots of an advanced settings page 2405 of the tool. FIGS. 24-28 show the page as it is being advanced. The advanced settings page may be accessed by selecting the gear icon in the upper left hand corner of the page. These settings can allow the user to fine-tune the tool. As shown in FIGS. 24-28, there is a “Send Statistics” option 2410 (FIG. 24), a set of boundary settings 2415 (FIGS. 24-28), a set of display settings 2615 (FIGS. 26-27), a Huewindow Width setting 2715 (FIG. 27), a Huewindow Scale setting 2815, an HQ Sat Spike setting 2820, a Whitebalance Divisor 2825, and a reset button 2830 (FIG. 28).

The “Send Statistics” option 2410 allows the user to authorize the sending of anonymous usage statistics to a central server. The usage information may include information identifying which filters have been used, which filters have not been used, a particular filter setting, a length of time or duration that a filter was used, and so forth. The usage information can be used to further refine the filters, create new filters, remove infrequently used filters, or combinations of these. For example, if the usage information indicates that a particular filter is not being used very often, the particular filter may be removed in a later release of the tool. This can help reduce the size of the tool and conserve storage resources. If the usage information indicates that a particular filter is being frequently used, the particular filter may be enhanced with other features so that, for example, the image processing time of the filter can be improved.

As shown in the FIGS. 24-28, each setting includes a corresponding input box. Each of the boundary settings and the display settings further includes a color and corresponding slider. The input box indicates the default value. For example, the boundary setting for “red” indicates a default value of 0.12. The user can change the default value using the slider or by inputting a different value in the input box. In a specific implementation, the boundary settings define the point at which a color is no longer seen as red, orange, yellow, green, cyan, blue, or magenta.

The display settings define how an interpreted red, orange, yellow, green, cyan, blue, or magenta is displayed. The hue window width setting specifies how many hues to display at once during HueWindow mode. The hue window scale setting specifies to what degree non-displayed hues are still allowed to be faintly visible. The HQ saturation spike specifies how much saturation is increased during Hue Quantization. The white balance divisor specifies how powerful the white balance effect can be (at the cost of throwing away data). The reset button resets the values to their normal or default values.

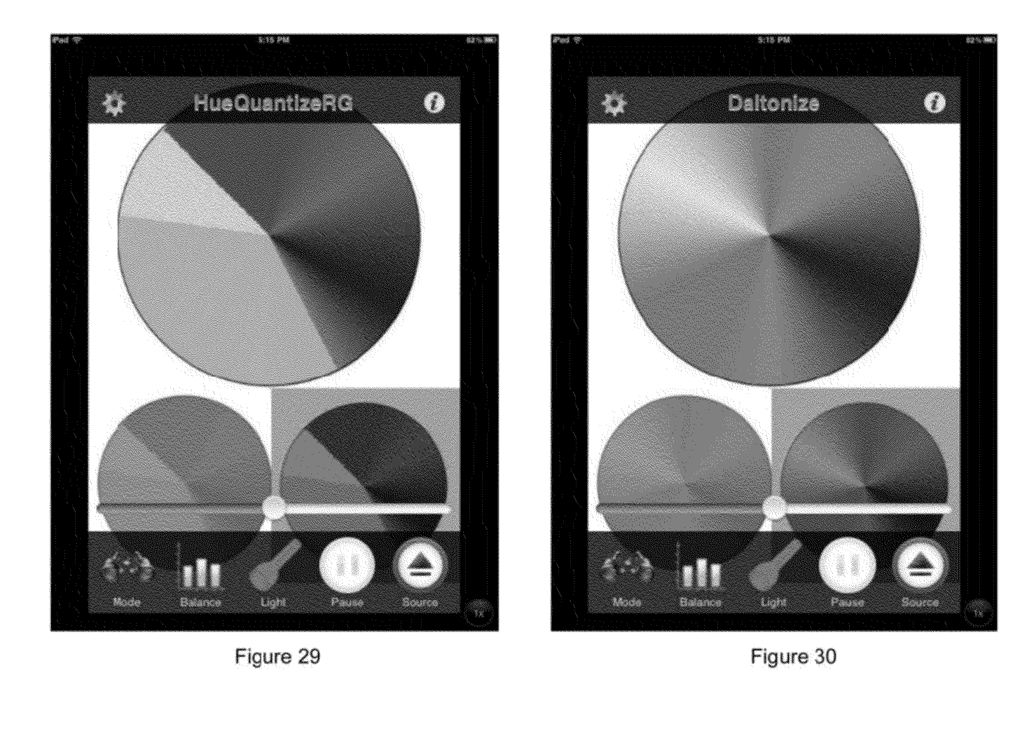

FIG. 29 shows a screenshot of the color wheel image having been altered by a filter labeled HueQuantizeRG. This filter converts all colors between red and green to red, yellow, or green-cyan.

FIG. 30 shows a screenshot of the color wheel image having been altered by a filter labeled Daltonize. This filter makes reds pinking while increasing the strength of green.

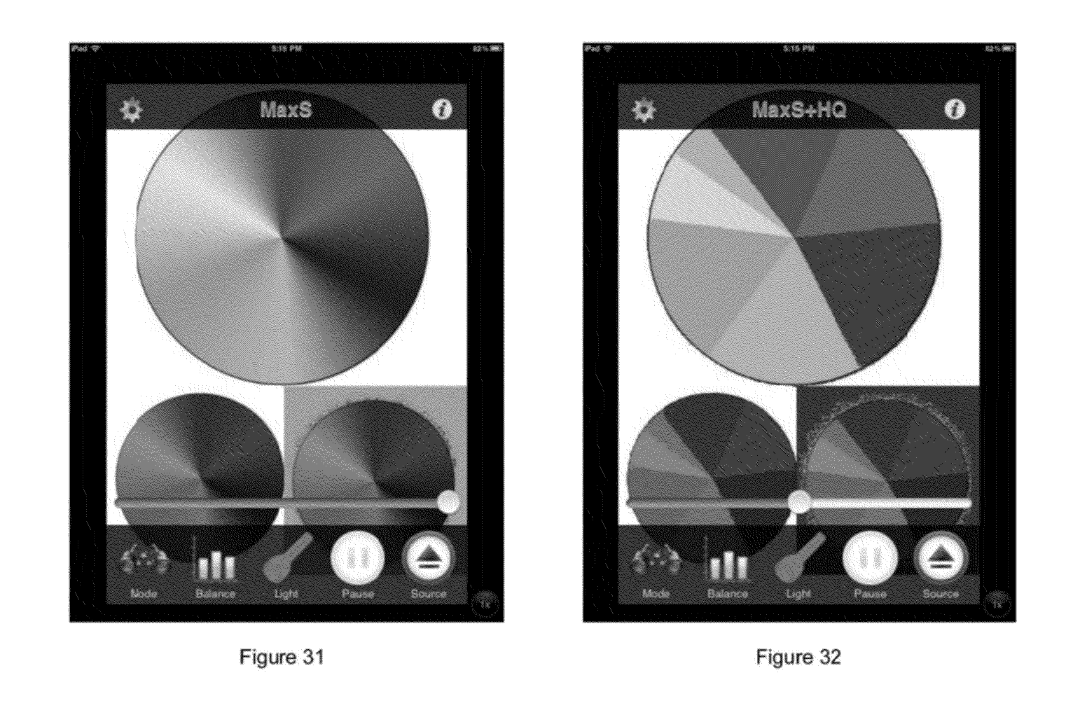

FIG. 31 shows a screenshot of the color wheel image having been altered by a filter labeled MaxS. This filter increase the saturation of the colors.

FIG. 32 shows a screenshot of the color wheel image having been altered by a filter labeled MaxS+HQ. This filter is a combination of the MaxS plus HueQuantize filter. This may be referred to as the “brute force” solution.

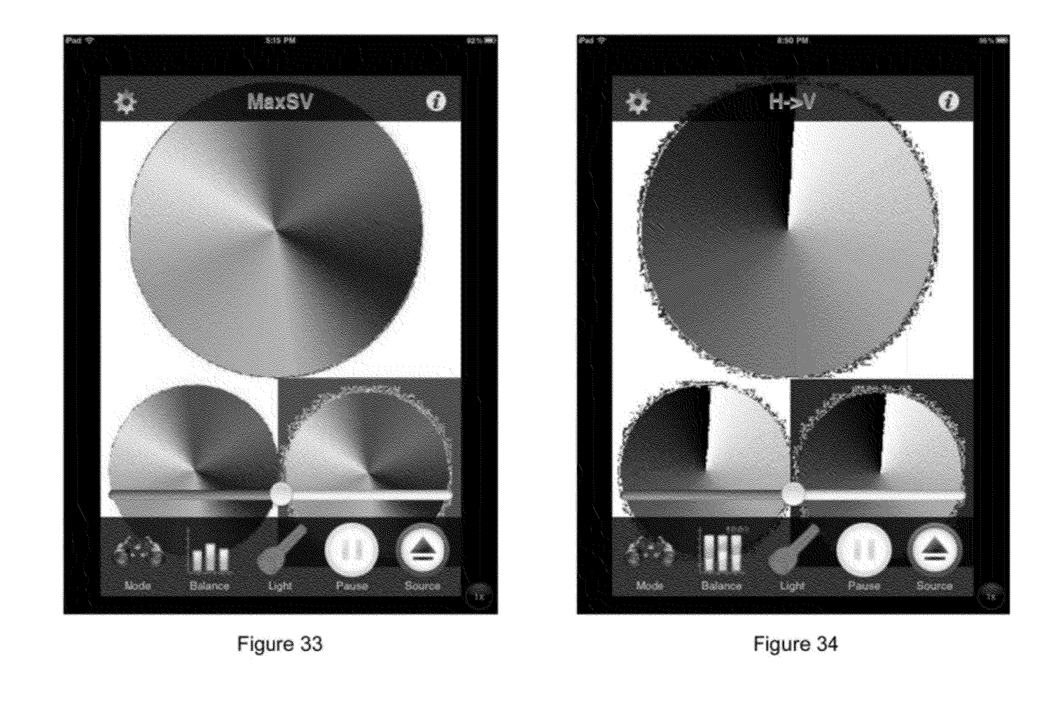

FIG. 33 shows a screenshot of the color wheel image having been altered by a filter labeled MaxSV. This filter includes the MaxS filter with the addition that the brightness of pixels has been increased. In a specific implementation, all pixels are made as bright as possible.

FIG. 34 shows a screenshot of the color wheel image having been altered by a filter labeled H->V. In this filter red through magenta is translated to black through white.

Referring now to FIG. 10, in this specific implementation, the tool includes icons, buttons, or controls 1040B-E, a zoom out/zoom in button 1045, and an information button 1050. Button 1040B is the control for white balance. The human visual system is skilled at determining whether something is a given color because of the way it reflects light versus the nature of the light around it. Generally, this is relatively hard for computers, especially one that will take a red tinge and convert it into a hard red. With white balance enabled, the tool attempts to look at a scene and guess or estimate from the popularity of certain colors what might be coming from the environment.

Button 1040C is the control for the light. This control can be used to turn on the light or flash of the portable electronic device. In some cases, this can provide a clean predictable source of light and thus improved color determination. This is not always the case, however, because the perceived color of an object can vary greatly depending upon the distance between the light and the object.

Button 1040D is the control for freezing or pausing the camera. For example, a real-time or live image feed shown on the screen may be paused by pressing the icon button. Once the image has been paused the user no longer has to keep the camera pointed at the scene. The user can see the results of different filters being applied to the image without having to keep the camera pointed at the scene.

Button 1040E is the control for selecting or identifying an input source of the image. In this specific implementation, the application can operate on either camera, one of a number of built-in images, or any image in the user's photo library. For example, the built-in Ishihara tests are considered by many to be the gold standard for detecting color blindness. The built-in color wheel can be useful for seeing what is happing filterwise.

Zoom out/zoom in button 1045 allows the user to zoom in and out on the image. In some cases, size matters in color blindness. A color may be more distinguishable when it is presented as a large region where each portion of the region is of the same hue. Information button 1050 provides a description of the tool.

In a specific implementation, a system provides one or more visual filters that allow the color blind to see images that otherwise might be difficult, due to differences in their photoreceptors. A technique that may be referred to as Hue Quantization is based on the finding that there appears to be a layer in the human visual system that sees color according to HSV (or variants, HSB/HSL). It is precisely this system that is confused by the broken YUV signal coming in. In this specific implementation, the technique includes canonicalizing H—all colors within a range of possible subhues are made a canonical value. For example, on a scale from 0 to 32, a hue of 1.0 (an imperceptibly orange red) is made a flat red. Research has shown that there appears to be a layer in the human visual system that sees color according to HSV (or variants, HSB/HSL). This system may be confused by the broken YUV signal coming in. The YUV color model is intended to represent the human perception of color more closely than the RGB model used in computer graphics hardware. In YUV, Y corresponds to the luminance or brightness component while U and V are the chrominance or color components.

Hues are not actually constant across Saturation and Brightness values. In another specific implementation, a technique includes “punching up” or increasing saturation, by, for example, adding to S, multiplying S, setting S to a fixed higher value, or scaling S similar to the “simple white balance” mechanism or technique described in this application.

It is likely the visual system is only really seeing six hues: red, yellow, green, cyan, blue, and magenta. Orange is a possible seventh, with purple a probable eighth. (There will be some interesting overlap with languages, but some experiments have shown that this correct). Typically, the color blind tend to have issues differentiating around reds, oranges, yellows, and greens. So, in a specific implementation, a technique includes quantizing only around these, including, for example, pushing green clean into cyan.

In various specific implementations, a technique includes quantizing within the Daltonized space. A technique includes specifically setting S=1 and hue quantize. This has been shown to provide desirable results. A technique includes setting both S and B to 1, letting only H float. A technique includes setting S to 0, rendering everything black and white (making hue irrelevant). Then set B to H.

In another specific implementation, a technique includes creating a “window” of visible hues. For instance, show only blues. Pixels can be set to black outside the window, or to half brightness, or to full brightness, or desaturated. This may be accomplished through the use of a tuning slider.

Regarding tuning, there can be some variability even among anomalous trichromats. For example, many but not all have no concept of the color orange between red and yellow. In a specific implementation, as a user interface element, a slider is added that applies a scalable transform (linear or otherwise) to the input boundaries for the hue canonicalizers. For example, if a hue boundary was placed at 3 and another at 6, but the slider was shifted to 0.9, the new input boundaries could be 2.7 and 5.4 respectively. There are many possible transforms and ranges this could take. Generally, the technique involves taking the 1d or 2d input from the user and tune constants.

In a specific implementation, tuning slider can and will do different things for different filters. A generic action can be to just rotate hue, or a specific action can be to alter the hue window or even alter saturation levels. The slider action can be dynamically selected.

In some cases, there may be issues with albedo and white balance. Essentially, it is difficult to separate the true color of an object versus the reflected light from the ambient source. In a specific implementation, a technique to address this issue includes running a histogram stretcher, with some “overage” compensation to handle noisy pixels. In another specific implementation, a technique includes performing object segmentation/graph cuts to separate the image, and then independently operating on the components. In another specific implementation, a technique for white balance is to “own” the light source, say from an LED torch built into a phone.

Table B below shows an example of code a specific implementation of an augmented reality application program for the color blind.

```
TABLE B
import JMyron.*;
import controlP5.*;
JMyron m;//a camera object
ControlP5 controlP5;
int useimg = 13;
int tmode=1;
controlP5.Button modebutton;
controlP5.Slider tuningslider;
float minshift = 0.35;
float maxshift = 1.65;
// MAGIC DEFINES -- TO BE USED IN UI
float in_r = 3.75;
float in_o = 5.25;
float in_y = 7.5;
float in_g = 12.5;
float in_c = 18.0;
float in_b = 24.0;
float in_m = 30.0;
float out_r=30.2; //30.2; //31.2−1;
float out_o=3.6;
float out_y=6.2; //5.2+1;
float out_g=12.5;//12.5; //9.5+3;
float out_c=15.8;
float out_b=20.0;
float out_m=26.3;
float huewindow_width = 0.05; // should be a slider from 0 to 1
float huewindow_scale = 0.25; // should be a slider from 0 to 1 //NEW
int whitebalance_divisor = 10; // should be a slider from 0 to 200
float hq_sat_spike = 1.25; // should be a slider from 1.0 to 2.0
int[ ] hist_r;
int[ ] hist_g;
int[ ] hist_b;
int[ ] map_r;
int[ ] map_g;
int[ ] map_b;
int min_r;
int max_r;
int min_g;
int max_g;
int min_b;
int max_b;
void setup( ){
  m = new JMyron( );
  m.start(320,480);
  m.findGlobs(0);
  size(320,480);
  controlP5 = new ControlP5(this);
  modebutton = controlP5.addButton(“Mode”, 0, 0, 460, 70, 20);
  modebutton.setLabel(“HueQuantize”);
  controlP5.addButton(“Light”, 10, 180, 460, 40, 20);
  controlP5.addButton(“Snap”, 10, 270, 460, 70, 20).setLabel(“Freeze”);
  tuningslider = controlP5.addSlider(“Tuning”,minshift,
  maxshift,1.0,0,430,320,20);
  controlP5.addButton(“Img”, 10, 0, 0, 80,
  20).setLabel(“Change Image”);
  controlP5.addButton(“WhiteBalance”, 0, 80, 460, 70, 20);
  controlP5.addButton(“Advanced”, 10, 140, 0, 50, 20);
  controlP5.addButton(“?!”, 10, 300, 0, 20, 20);
  off_r = 0;
  off_g = 0;
  off_b = 0;
  off_avg = 0;
  off_mult=1;
  fc=0;
  //WHITE BALANCE
  wb=false;
  hist_r = new int[256];
  hist_g = new int[256];
  hist_b = new int[256];
  map_r = new int[256];
  map_g = new int[256];
  map_b = new int[256];
  for(int i=0; i<=255; i++){
    map_r[i]=map_g[i]=map_b[i]=i;
  }
}
float baserb = in_r/32;
float baseob = in_o/32;
float baseyb = in_y/32;
float basegb = in_g/32;
float basecb = in_c/32;
float basebb = in_b/32;
float basemb = in_m/32;
float shift = 1.0;
float cvd_a = 1.0;
float cvd_b = 0.0;
float cvd_c = 0.0;
float cvd_d = 0.494207;
float cvd_e = 0.0;
float cvd_f = 1.24827;
float cvd_g = 0.0;
float cvd_h = 0.0;
float cvd_i = 1.0;
boolean wb = true;
boolean do_update = true;
int sum_r;
int sum_g;
int sum_b;
int asum_r;
int asum_g;
int asum_b;
int rgb_count;
int off_r, off_g, off_b, off_avg;
float off_mult;
int fc;
float oh, nh;
void draw( ){
  int[ ] img;
  PImage pimg;
  switch(useimg){
    case 1: img = loadImage(“ishi1.png”).pixels; break;
    case 2: img = loadImage(“ishi2.png”).pixels; break;
    case 3: img = loadImage(“color_wheel.png”).pixels; break;
    default:
      useimg=0;
      if(do_update) { m.update( );}
      img = m.image( );
  }
  loadPixels( );
  float rb = baserb * shift;
  float ob = baseob * shift;
  float yb = baseyb * shift;
  float gb = basegb * shift;
  float cb = basecb * shift;
  float bb = basebb * shift;
  float mb = basemb * shift;
  int r,g,b,pixelColor;
  sum_r=0;
  sum_g=0;
  sum_b=0;
  rgb_count=width*height;
  fc++;
  if(wb==true){
    for(int i=0; i<=255; i++){
      hist_r[i]=hist_g[i]=hist_b[i]=0;
    }
    for(int i=0; i<width*height; i++){
      pixelColor = img[i];
      r = ((pixelColor >> 16) & 0xff);
      g = ((pixelColor >> 8) & 0xff);
      b = (pixelColor & 0xff);
      hist_r[r]+=1;
      hist_g[g]+=1;
      hist_b[b]+=1;
    }
    int sum_r=0;
    int sum_g=0;
    int sum_b=0;
    int min_r=0;
    int min_g=0;
    int min_b=0;
    int max_r=255;
    int max_g=255;
    int max_b=255;
    int barrier = (width*height)/whitebalance_divisor;
    while(sum_r < barrier){ sum_r+=hist_r[min_r]; min_r++; }
    while(sum_g < barrier){ sum_g+=hist_g[min_g]; min_g++; }
    while(sum_b < barrier){ sum_b+=hist_b[min_b]; min_b++; }
    sum_r = sum_g = sum_b = 0;
    while(sum_r < barrier){ sum_r+=hist_r[max_r]; max_r−−; }
    while(sum_g < barrier){ sum_g+=hist_g[max_g]; max_g−−; }
    while(sum_b < barrier){ sum_b+=hist_b[max_b]; max_b−−; }
    float r_shift, g_shift, b_shift;
    r_shift = 255.0 / (max_r−min_r);
    g_shift = 255.0 / (max_g−min_g);
    b_shift = 255.0 / (max_b−min_b);
    for(int i=0; i<=255; i++){
      if(i < min_r) { map_r[i] = 0; }
      else{ map_r[i] = int((i − min_r) * r_shift); }
      if(map_r[i]>255) { map_r[i] = 255; }
      if(i < min_g) { map_g[i] = 0; }
      else{ map_g[i] = int((i − min_g) * g_shift); }
      if(map_g[i]>255) { map_g[i] = 255; }
      if(i < min_b) { map_b[i] = 0; }
      else{ map_b[i] = int((i − min_b) * b_shift); }
      if(map_b[i]>255) { map_b[i] = 255; }
    }
  }
  for(int i=0; i<width*height; i++){
    float[ ] hsb = new float[3];
    pixelColor = img[i];
    int orig_r, orig_g, orig_b;
    r = orig_r = ((pixelColor >> 16) & 0xff);
    g = orig_g = ((pixelColor >> 8) & 0xff);
    b = orig_b = (pixelColor & 0xff);
    if(wb==true){
      r = map_r[orig_r];
      g = map_g[orig_g];
      b = map_b[orig_b];
    }
    int pc=0;
    Color.RGBtoHSB(r,g,b,hsb);
    oh = hsb[0];
    switch(tmode){
      case 0:
        float shift2 = shift;
        hsb[0] += shift;
        if(hsb[1]>1) { hsb[1]=1; }
        break;
      case 1:
        if(hsb[0] < rb) { hsb[0]=out_r/32; } else
        if(hsb[0] < ob) { hsb[0]=out_o/32; } else
        if(hsb[0] < yb) { hsb[0]=out_y/32; } else
        if(hsb[0] < gb) { hsb[0]=out_g/32; } else
        if(hsb[0] < cb) { hsb[0]=out_c/32; } else
        if(hsb[0] < bb) { hsb[0]=out_b/32; } else
        if(hsb[0] < mb) { hsb[0]=out_m/32; } else
        hsb[0] = out_r/32;
        hsb[1]*=hq_sat_spike;
        if(hsb[1]>1) { hsb[1]=1; }
        break;
      case 2:
        //intentionally doesn't use magic vars...these #'s
        are VALIDATED
        if(hsb[0] < (4.5/32)*shift) { hsb[0]=0.0/32; } else
        if(hsb[0] < (7.5/32)*shift) { hsb[0]=4.5/32; } else
        if(hsb[0] < (18.0/32)*shift) { hsb[0]=15.0/32; }
        break;
      case 3:
        // RGB to LMS matrix conversion
        float L = (17.8824 * r) + (43.5161 * g) + (4.11935 * b);
        float M = (3.45565 * r) + (27.1554 * g) + (3.86714 * b);
        float S = (0.0299566 * r) + (0.184309 * g) + (1.46709 * b);
        // Simulate color blindness // DMK: Er, at least try to :)
        float l = (cvd_a * L) + (cvd_b * M) + (cvd_c * S);
        float m = (cvd_d * L) + (cvd_e * M) + (cvd_f * S);
        float s = (cvd_g * L) + (cvd_h * M) + (cvd_i * S);
        // LMS to RGB matrix conversion
        float R = (0.0809444479 * 1) + (−0.130504409 * m) +
        (0.116721066 * s);
        float G = (−0.0102485335 * 1) + (0.0540193266 * m) +
        (−0.113614708 * s);
        float B = (−0.000365296938 * 1) + (−0.00412161469 * m) +
        (0.693511405 * s);
        // Isolate invisible colors to color vision deficiency
        (calculate error matrix)
        R = r − R;
        G = g − G;
        B = b − B;
        // Shift colors towards visible spectrum (apply error
        modifications)
        float RR = (0.0 * R) + (0.0 * G) + (0.0 * B);
        float GG = (0.7 * R) + (1.0 * G) + (0.0 * B);
        float BB = (0.7 * R) + (0.0 * G) + (1.0 * B);
        // Add compensation to original values
        R = RR + r;
        G = GG + g;
        B = BB + b;
        // Clamp values
        if(R < 0) R = 0;
        if(R > 255) R = 255;
        if(G < 0) G = 0;
        if(G > 255) G = 255;
        if(B < 0) B = 0;
        if(B > 255) B = 255;
        // Record color
        r = int(R);
        g = int(G);
        b = int(B);
        Color.RGBtoHSB(r,g,b,hsb); // ok, yes, this is a horrible hack...
        hsb[0] += shift; //...but it enables hue rotation on daltonization
        break;
      case 4:
        if(r>245 && g>245 && b>245) { break; }
        if(r<10 && g<10 && b<10) { break; }
        hsb[1]*=(shift*2); //NEW: This is doubled
        if(hsb[1]>1) { hsb[1]=1; }
        break;
      case 5:
        if(r>245 && g>245 && b>245) { break; }
        if(r<10 && g<10 && b<10) { break; }
        hsb[1]=1;
        if(hsb[0] < rb) { hsb[0]=out_r/32; } else
        if(hsb[0] < ob) { hsb[0]=out_o/32; } else
        if(hsb[0] < yb) { hsb[0]=out_y/32; } else
        if(hsb[0] < gb) { hsb[0]=out_g/32; } else
        if(hsb[0] < cb) { hsb[0]=out_c/32; } else
        if(hsb[0] < bb) { hsb[0]=out_b/32; } else
        if(hsb[0] < mb) { hsb[0]=out_m/32; } else
        hsb[0] = out_r/32;
        //hsb[1] *= 1.1;
        //if(hsb[1]>1) { hsb[1]=1; }
        //hsb[0]+=shift;
        break;
      case 6:
        if(r>245 && g>245 && b>245) { break; }
        if(r<10 && g<10 && b<10) { break; }
        hsb[0]+=shift;
        hsb[1]=1;
        hsb[2]=1;
        break;
      case 7:
        hsb[2]=hsb[0]*shift;
        hsb[1]=0.0;
        break;
      case 8:
        shift2 = shift;
        shift2 −= minshift;
        shift2 *= (1.0/(maxshift − minshift));
        if(abs(hsb[0]−shift2)>huewindow_width)
        { hsb[2]*=huewindow_scale; }
        break;
      default:
        tmode=0;
        break;
    }
    pixels[i] = Color.HSBtoRGB(hsb[0],hsb[1],hsb[2]);
    }
  updatePixels( );
}
void Tuning(float val){
  shift = val;
}
void Snap(float val){
  do_update = !do_update;
}
void Img(float val){
  useimg+=1;
}
void WhiteBalance(float val){
  wb = !wb;
  fc=0;
}
void Mode(float val){
  tuningslider.setValue(1.0);
  tmode+=1;
  switch(tmode){
    case 1: modebutton.setLabel(“HueQuantize”); break;
    case 2: modebutton.setLabel(“HueQuantizeRG”); break;
    case 3: modebutton.setLabel(“Daltonize”); break;
    case 4: modebutton.setLabel(“MaxS”);
    tuningslider.setValue(maxshift); break;
    case 5: modebutton.setLabel(“MaxS+HQ”); break;
    case 6: modebutton.setLabel(“MaxSV”); break;
    case 7: modebutton.setLabel(“H->V”); break;
    case 8: modebutton.setLabel(“HueWindow”); break;
    default:
      tmode=0;
      modebutton.setLabel(“Unfiltered”);
      break;
  }
}
```

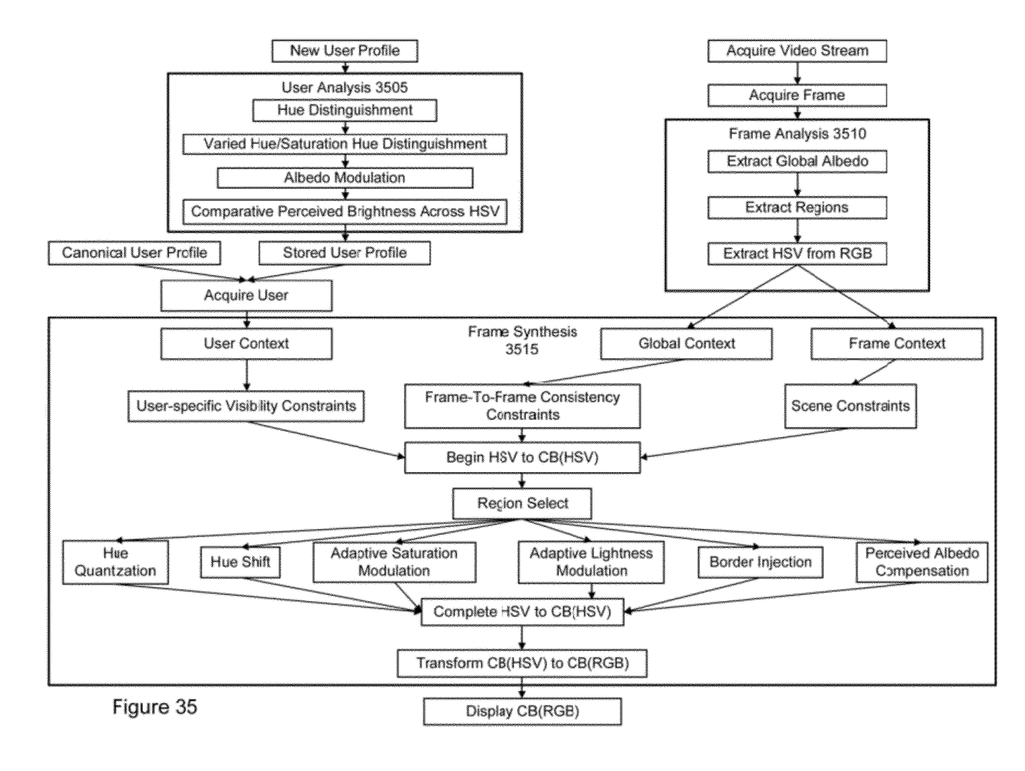

FIG. 35 shows a functional block diagram of another specific implementation of an augmented reality tool for color blindness. FIG. 35 shows modules or process modules and arrows between the modules. These arrows represent data pathways between the modules so that one module can pass data to another module and vice versa. The data pathways may be across a network (such as Ethernet or Internet) or may be within a single computing machine (e.g., a portable electronic device), such as across buses or memory-to-memory or memory-to-hard-disk or memory-to-storage-device transfer. The data pathways can also be representative of a module, being implemented as a subroutine, passing data in a data structure (e.g., variable, array, pointer, or other) to another module, which may also be implemented as a subroutine.

The modules represent how data and data process procedures are organized in a specific system implementation, which facilities providing an augmented reality experience for color blind people in an efficient and organized manner. Data can more quickly be accessed and drawn on the screen. System response time is fast and the user does not have to do a lot of repetition to obtain the results the user desires.

This specific implementation includes a user analysis process 3505, a frame analysis process 3510, and a frame synthesis process 3515. A new user profile is provided as input to the user analysis process. User analysis includes hue distinguishment, varied hue/saturation hue distinguishment, albedo modulation, and comparative perceived brightness across HSV.

The output from user analysis may be stored such as in stored user profile. Data from the stored user profile is provided as input to acquire user which also receives as input a canonical user profile. Acquire user outputs to the frame synthesis process, and more particularly to user context to user-specific visibility constraints to begin HSV to CB(HSV). In a specific implementation, before beginning the conversion of HSV to CB(HSV), there is a process step to acquire video stream and acquire frame. In the frame analysis process the acquired frame is analyzed. The analysis includes extract global albedo, extract regions, and extract HSV from RGB. Output from the frame analysis is provided as inputs to the frame synthesis process, and more particularly, to global context and frame context. From the frame context there may be scene constraints. From the global context there may be frame-to-frame consistency constraints. These constraints are provided to the begin HSV to CB(HSV) process. This process includes a region select which may further include one or more of a hue quantization, a hue shift, an adaptive saturation modulation, an adaptive lightness modulation, a border injection, or a perceived albedo compensation. This completes HSV to CB(HSV). There is the further step of transform CB(HSV) to CB(RGB) and the output is display CB(RGB).

In a specific implementation, there is a technique for white balancing. White balancing refers to adjusting the color balance in an image to compensate for the color temperature of the illumination source. The adjustment can remove unrealistic color casts, so that objects which appear white in the physical real-world scene are rendered white. In this specific implementation, the technique includes capturing data about the environment surrounding the scene. This may include instructing the user to wave the portable electronic device around their environment so that the tool capture the data. The tool may receive information from an accelerometer of the device indicating that the device is moving. The tool may then determine the average colors in the environment.

In a specific implementation, a technique for calibration includes calibrating using a user's skin or calibrating against skin tone. For example, a gray card is sometimes used in film and photography to provide a standard reference object for exposure determination, white balance, or color balance. Carrying around gray card can be inconvenient. Skin, however, is something that every person “carries around.”

In this specific implementation, a calibration technique includes instructing the user to calibrate against their skin such as by instructing the user to point the camera lens at their hand. Applicant has discovered that the relative ratios of light coming off or reflecting from skin or melamine is fairly consistent. A first calibration includes instructing the user to take a photo of their skin (e.g. hand) using sunlight as a light source. That is, to take the photo outside or under sunlight conditions. Information related to the photograph of the skin is saved as a reference. Afterwards, when the user desires to use the camera under different (or the same lighting conditions), the user can perform a second calibration by pointing the camera at their hand again and taking another picture. The information gathered from the second calibration is compared against the stored information from the first calibration so that the colors can be properly balanced. The reference information allows the system to determine what a particular red looks like in a given light. It should be appreciated that this technique is applicable to devices such as video cameras, digital cameras, or both.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. A method comprising:
receiving an image of an object from a camera of a portable electronic device;
analyzing, at the portable electronic device, the image to obtain a hue value representing a color of the object;
identifying a predetermined range of hue values, wherein the hue value is within the predetermined range, and the predetermined range is mapped to a specific predetermined hue value;
replacing the hue value representing the color of the object with the specific predetermined hue value to color the object using the specific predetermined hue value; and
displaying on a screen of the portable electronic device an altered image, wherein the altered image comprises the object colored using the specific predetermined hue value to permit a color blind person viewing the screen to perceive the color of the object as would be perceived by a non-color blind person viewing the object.

2. The method of claim 1 wherein the specific predetermined hue value is outside the predetermined range of hue values.

3. The method of claim 1 wherein the specific predetermined hue value is within the predetermined range of hue values.

4. The method of claim 1 wherein the specific predetermined hue value is greater than an upper limit of the predetermined range of hue values.

5. The method of claim 1 wherein the specific predetermined hue value is less than a lower limit of the predetermined range of hue values.

6. The method of claim 1 wherein the specific predetermined hue value is equal to an upper limit of the predetermined range of hue values.

7. The method of claim 1 wherein the specific predetermined hue value is at least two times greater than an upper limit of the predetermined range of hue values.

8. The method of claim 1 wherein the altered image does not comprise text indicating the color of the object.

9. A method comprising:
receiving from a camera of a portable electronic device an image of an object having a color to be displayed on a screen of the portable electronic device;
displaying on the screen a user-selectable filter control;
detecting a user-adjustment to the user-selectable filter control; and
altering the image displayed on the screen in response to the user-adjustment to permit a color blind person viewing the altered image to perceive the color of the object as would be perceived by a non-color blind person viewing the object.

10. The method of claim 9 comprising maintaining the displayed user-selectable filter control with the altered image.

11. The method of claim 9 wherein the user-selectable filter control is overlaid on top of the altered image.

12. The method of claim 9 wherein the user-selectable filter control is closer to a bottom edge of the screen than a top edge of the screen.

13. The method of claim 9 wherein the altering the image comprises highlighting a single color of the object.

14. A method comprising:
receiving live video of a scene captured through a camera of a portable electronic device, the scene comprising a plurality of colors;
altering the live video to highlight a single color of the plurality of colors; and
displaying in real-time on a screen of the portable electronic device the altered live video having the highlighted single color, wherein the altered live video permits a color blind person viewing the screen to perceive the single color as would be perceived by the non-color blind person viewing the scene.

15. The method of claim 14 wherein the altering the live video comprises changing a color parameter associated with the single color.

16. The method of claim 15 wherein during the altering the live video color parameters associated with colors other than the single color are not changed.

17. The method of claim 14 wherein the altering the live video comprises changing color parameters associated with colors other than the single color.

18. The method of claim 17 wherein during the altering the live video a color parameter of the single color is not changed.

19. The method of claim 14 wherein the altering the live video is based on a filter selected by a user of the portable electronic device.

20. The method of claim 14 comprising permitting a user to select a color to be highlighted.
